(19) United States
(12) Patent Application Publication
(10) Pub. No.: US 2007/0170379 A1
(43) Pub. Date: Jul. 26, 2007

(54) Cooled optical filters and optical systems comprising same

(75) Inventors: Douglas C. Watson, Campbell, CA (US); Alton H. Phillips, East Palo Alto, CA (US); Michael R. Sogard, Menlo Park, CA (US)

Correspondence Address: KLARQUIST SPARKMAN, LLP, 121 SW SALMON STREET, SUITE 1600, PORTLAND, OR, 97204, US

(73) Assignee: Nikon Corporation

(21) Appl. No.: 11/338,951

(22) Filed: Jan. 24, 2006

(51) Int. Cl. G21F 3/00

(52) U.S. Cl. 250/515.1

(57) ABSTRACT

An exemplary apparatus for filtering electromagnetic radiation includes a filter element, an actuator, and a filter-cooler. The filter element has multiple selectable regions situated so that electromagnetic radiation impinges on a selected filter region to transmit therethrough a first wavelength while limiting transmission of a second wavelength. Absorption of impinging radiation heats the filter element, but the actuator moves the filter element to select a particular filter region for impingement by the radiation while moving another region away from impingement by the radiation. The filter-cooler directs a heat-conduction medium (e.g., a gas) at, and thus cools, the moved-away region. By such ongoing refreshment of portions of the filter element being irradiated and portions being cooled, the filter element can be irradiated for extended periods without thermal damage. An important use is in optical systems for EUV lithography.

### FIELD

This disclosure pertains to, inter alia, sources of extreme ultraviolet (EUV) light and to exposure systems including or otherwise associated with such sources. The subject exposure systems include, but are not limited to, lithography systems as used for fabricating microelectronic devices such as integrated circuits and displays. More specifically, the disclosure pertains to optical filters, termed spectral-purity filters, that are used in such sources and optical systems for reducing downstream propagation of out-of-band radiation from an EUV source.

### BACKGROUND

Among several candidate “next-generation lithography” technologies for use in the manufacture of semiconductor integrated-circuit devices, displays, and other highly miniaturized devices is “extreme ultraviolet lithography” (EUVL). EUVL is lithography performed using a wavelength of electromagnetic radiation in the range of 11 to 14 nm, which is within the “extreme ultraviolet” or “soft X-ray” portion of the electromagnetic spectrum. EUVL offers prospects of greater image resolution than are currently obtainable using “optical” lithography, of which the shortest wavelengths currently in use are in the range of 150-250 mm.

A current challenge in the development of a practical EUVL system is providing a convenient source of EUV exposure “light” capable of providing an EUV beam at sufficient intensity at the desired wavelength for making lithographic exposures at an acceptable throughput. A powerful source of EUV light is synchrotron radiation. Unfortunately, very few fabrication plants at which EUVL would be performed have access to a synchrotron, which is extremely large and extremely expensive to install and operate. As a result, substantial research and development effort is currently being directed to the development of alternative sources of EUV light. The two principal approaches in this development involve the production of a plasma of a target material, wherein the plasma produces EUV radiation. In one method the plasma is produced by electrical discharge in the vicinity of the target material, and in the other method the plasma is produced by laser irradiation of the target material. The EUV radiation produced by both methods is pulsed. Whereas these methods have advantages of portability as well as relatively compact size and low cost of operation (especially relative to a synchrotron), they have several disadvantages. One disadvantage is the difficulty of producing a sufficiently intense beam of EUV light at the desired wavelength for desired high-throughput exposures. Another disadvantage is that the respective plasmas produced by these sources tend to generate gases and fine debris that deposit on nearby components, especially nearby optical components. In view of the extremely high performance demanded of EUV-optical elements, significant contamination of them by debris and gases from the EUV source simply cannot be tolerated.

Because no materials are known that are sufficiently transmissive and refractive to EUV light to serve as EUV lenses, EUV optics comprise reflective optical elements (i.e., mirrors). Except for grazing-incidence mirrors, all EUV mirrors have a respective surficial multilayer film that provides the mirror surfaces with a useful reflectivity to incident EUV light. For EUVL, these mirrors must be fabricated to extremely demanding tolerances and must exhibit extremely high optical performance.

Since EUV light is greatly attenuated and scattered by the atmosphere, the propagation pathway for EUV radiation in an EUVL system is evacuated to a vacuum. This requires that the EUVL optics (e.g., illumination optics and projection optics) be contained in at least one vacuum chamber that is evacuated to a desired vacuum level. Similarly, a plasma EUV source as summarized above is contained in a vacuum chamber (termed an “EUV-source chamber”) that is evacuated to a desired vacuum level. Hence, EUV light generated in the plasma EUV source must propagate from the EUV-source chamber to the chamber containing the EUVL optics.

In the plasma EUV source, EUV light and other wavelengths of light produced by the plasma are collected into a beam. Light collection can be achieved using, for example, one or more collector mirrors situated near the plasma. From the collector mirror(s) the beam passes through the intermediate focus plane of the collector mirror(s), between the source and downstream EUV optics. From the intermediate focus plane the beam is directed as an “illumination beam” to an illumination unit (“illumination-optical system”) contained in an illumination-unit chamber. The illumination-optical system, which is part of the EUVL optics, comprises various mirrors that collectively direct, shape, and condition the illumination beam as required for illumination of a pattern-defining reticle or other “pattern master” situated downstream of the illumination-optical system. Along this beam path the beam passes through a spectral purity filter (SPF). The SPF may be located near the intermediate focus plane, or it may be located within the illumination-optical system.

The SPF is utilized because the beam collected from the plasma contains various wavelengths of EUV radiation as well as longer wavelengths of electromagnetic radiation such as infrared light, ultraviolet light, and visible light. Wavelengths other than the desired EUV wavelength are termed “out-of-band” wavelengths that, if not removed, can cause various problems including an undesirable amount of heating of the EUV optics, the reticle, the photoresist, and the lithographic substrate (wafer). Although most of the EUV radiation that is produced by the plasma and that is outside the specified EUV exposure bandwidth would be absorbed by the mirrors of the illumination-optical system, extraneous wavelengths of EUV light can cause exposure problems in the photoresist such as image blurring. Consequently, for exposure the EUV light desirably is substantially limited to the specified wavelength. Further blurring of the image in the photoresist can occur from out-of-band deep ultraviolet (DUV) radiation which can expose the photoresist as well.

The SPF is configured so as to block as much of the out-of-band wavelengths as possible, including longer wavelengths (IR, DUV, UV, visible) of light and unwanted wavelengths of EUV radiation. Also, if interposed between the plasma and the illumination-optical system, the SPF can serve as a physical barrier that at least slows down the rate at which debris and gases from the plasma migrate to the illumination-unit chamber and beyond. Thus, the SPF helps prevent at least some of the gases and debris from contaminating, degrading, or otherwise damaging the EUV-optical elements of the illumination-optical system. Also, because the SPF blocks longer wavelengths of radiation, it reduces heating of EUV-optical elements located downstream of the SPF, and thus reduces thermal deformation of the downstream EUV-optical elements, thereby improving their imaging performance. But, because EUV transmission through a conventional SPF decreases with increasing thickness of the SPF, as described in the following paragraph, the SPF must be very thin to provide adequate transmission of the desired EUV wavelength.

A conventional SPF is an approximately 100 nm thick foil of zirconium (Zr) or other suitable metal (e.g., niobium); the foil is produced by vacuum deposition and gently laid onto and bonded to a supporting mesh of wires (e.g., nickel). See, e.g., Powell, “Care and Feeding of Soft X-ray and Extreme Ultraviolet Filters,” Proceedings SPIE 1848:503, 1992; Powell et al., “Thin Film Filter Performance for Extreme Ultraviolet and X-ray Applications,” Optical Engineering 29(6):614, 1990. A conventional SPF has multiple disadvantages. First, although the Zr foil is very thin, it still absorbs approximately 30% of the incident 13.4-nm EUV radiation. No practical way has been found to make the foil significantly thinner (to increase desired EUV transmission), especially without seriously compromising its mechanical integrity. Second, a conventional SPF is extremely fragile. Increasing its strength and durability by increasing the thickness of the Zr foil is not practical because increased foil thickness blocks even more incident EUV transmission. Third, the metal mesh must be coarse to minimize absorption by the mesh of a substantial fraction of the incident EUV radiation. As a result, much of the Zr foil (spanning open regions of the mesh) is only weakly supported. Fourth, because the Zr foil is only weakly attached to the mesh, thermal conductivity between the foil and grid is not optimal. Fifth, being very thin, the foil has extremely low thermal mass. Since most of the radiation produced by the plasma is out-of-band, the SPF must absorb a large amount of power, which causes substantial heating of the SPF, and heat conduction from the SPF to the adjacent wall of the EUV-source chamber is inefficient due to the vacuum environment and the thinness of the foil. Consequently, the SPF's foil is highly vulnerable to thermal damage. Sixth, if the SPF is located near the intermediate focus plane, between the EUV source chamber and the illumination unit chamber, the respective vacuum levels in the EUV-source chamber and illumination-unit chamber are often different, and the resulting pressure differential between the two chambers may impart substantial stress to the SPF. Seventh, depending upon the nature of any debris-mitigation system upstream of it, the SPF may be vulnerable to erosion or deposition damage as well as additional heating from particles emitted from the plasma. Eighth, since the Zr foil is laid onto a metal mesh, the foil conforms somewhat to the surface topography of the mesh, which results in the SPF having poor flatness.

Whereas the conventional SPF summarized above has utility in the laboratory-scale EUVL systems developed to date, which operated with relatively low-intensity EUV beams, the conventional SPF may fail when subjected to the substantially higher-power EUV beam produced in the near future by a commercial-scale EUVL system. Thus, there is a need for SPFs that are more durable under actual-use conditions experience in commercial EUVL systems, especially without having to reduce the transmission of the SPF to the EUV wavelengths of interest.

In one conventional EUVL system utilizing a plasma-EUV source contained in a vacuum chamber, multiple individual SPFs are used that are mounted on a disc. Whenever the SPF currently being used is or becomes damaged, the disc is rotated to move a fresh SPF into position for filtering purposes. However, this device only provides replacement SPFs and does not prolong the usable life of any of the individual SPFs mounted to the disc.

### SUMMARY

In view of the deficiencies of conventional SPFs and analogous filter elements as summarized above, various apparatus and methods are provided for filtering electromagnetic radiation.

A first aspect is directed to apparatus for filtering electromagnetic radiation. An embodiment of such an apparatus comprises a filter element, an actuator, and a filter-cooling device. The filter element comprises multiple selectable filter regions that are situated relative to the electromagnetic radiation such that the electromagnetic radiation can impinge on a selected filter region of the filter element to transmit a first wavelength through the selected filter region while limiting transmission of a second wavelength through the selected filter region. The actuator is coupled to the filter element and is configured to move the filter element to select a particular filter region for impingement by the electromagnetic radiation while moving another filter region of the filter element away from impingement by the electromagnetic radiation. Thus, the “actuator” is any device (such as but not limited to a motor) that, when actuated, produces a motion impetus, and the actuator is “coupled” to the filter element in any manner that delivers the motion impetus to the filter element to cause motion of the filter element. The filter-cooling device is situated and configured to direct a heat-conduction medium at, and thus cool, at least a portion of the filter element. Thus, the filter-cooling device provides thermal protection for the filter element without stopping use of the filter element. The filter-cooling device can be configured to direct the heat-conduction medium at a filter region not being impinged by the electromagnetic radiation.

The electromagnetic radiation can be produced in a first chamber including a dividing wall that defines a window. In such an embodiment, to exit the first chamber the first wavelength propagates through the selected filter region and through the window. The dividing wall can separate the first chamber from a downstream second chamber, wherein the first wavelength passes through the selected filter region and the window to the second chamber. The first and second chambers can be evacuated to respective vacuum levels.

In an embodiment the filter element has a rotational axis. In such a configuration the actuator can comprise a motor coupled to the filter element so as to rotate the filter element to place the selected filter region for impingement by the electromagnetic radiation. In another embodiment the filter element is configured for reciprocating motion, wherein the actuator is configured to cause reciprocating motion of the filter element.

In certain embodiments the actuator moves the filter element continuously during use of the filter element. In other embodiments the actuator moves the filter element intermittently during use of the filter element. In yet other embodiments the actuator moves the filter element periodically during use of the filter element.

The filter-cooling device can comprise a cooling zone, wherein the actuator is configured to move filter regions of the filter element into and out of the cooling zone. In certain of these embodiments the actuator is coupled to the filter element to rotate the filter element to move filter regions of the filter element into and out of the cooling zone. If the heat-conduction medium is a gas, then the cooling zone can be configured to direct flow of the gas to a filter region in the cooling zone. The cooling zone further can comprise a heat sink, which can be actively cooled, that is configured to remove heat from the gas that has contacted the filter region in the cooling zone. The cooling zone further can comprise a gas-recovery device that is configured to recover gas that has contacted the filter region in the cooling zone. The gas-recovery device of such an embodiment can be situated so as to flank the gas-film-producing device.

The filter-cooling device can comprise multiple cooling zones, wherein the actuator is configured to move filter regions of the filter element into and out of the cooling zones.

In certain embodiments the filter element is configured as an EUV spectral purity filter element, wherein first wavelength of the electromagnetic radiation is a desired wavelength of EUV radiation, and the second wavelength of electromagnetic radiation is of a group of out-of-band wavelengths. In such embodiments the filter element can comprise a substrate having a first major surface configured to face upstream to receive the beam of electromagnetic radiation, a second major surface configured to face downstream, and a thickness between the major surfaces. The substrate defines multiple waveguides that extend through the thickness dimension and have respective openings on the first and second major surfaces, wherein the waveguides are at least partially transmissive to the desired wavelength of EUV radiation. An EUV-transmissive layer is on the second major surface, wherein the EUV-transmissive layer is at least partially transmissive to the desired wavelength and covers the waveguide openings on the second major surface. On the first major surface is a reflective layer that is reflective to at least a first portion of the out-of-band radiation so as to prevent the first portion from entering the substrate. The waveguides attenuate at least a second portion of the out-of-band radiation entering the waveguides from the first major surface, so as to reduce the second portion passing through the waveguides to the EUV-transmissive layer.

According to another aspect, spectral purity filters (SPFs) are provided. An embodiment of such an SPF comprises a filter element, an actuator, and a cooling device. The filter element comprises multiple selectable filter regions that are situated relative to a beam of electromagnetic radiation such that the beam can impinge on a selected filter region to transmit a first wavelength of the electromagnetic radiation through the filter element and to limit transmission of a second wavelength of the electromagnetic radiation through the filter element, wherein impingement by the beam on a selected filter region causes heating of the filter region. The actuator is coupled to the filter element and is configured to move the filter element to select a first filter region for impingement by the beam while moving a second filter region of the filter element away from impingement by the beam. The cooling device is situated and configured to direct a heat-conduction medium at, and thus remove heat from, at least the second filter region. The cooling device can be configured to remove heat from at least the second filter region while the beam is impinging on the first filter region.

The actuator can be configured to move the filter element by, for example, rotation or reciprocating motion. The cooling device can comprise a gas-flow device that directs a flow of a gas to at least the second filter region. In such an embodiment the cooling device further can comprise a gas-recovery device that is situated and configured to recover gas of the gas flow that has contacted at least the second filter region.

The filter element can be configured as an EUV SPF element, wherein the first wavelength of the electromagnetic radiation is a desired wavelength of EUV radiation, and the second wavelength of electromagnetic radiation is of a group of out-of-band wavelengths. In these embodiments the filter element can comprise a substrate having a first major surface facing upstream to receive the beam of electromagnetic radiation, a second major surface facing downstream, and a thickness dimension between the major surfaces. The substrate can be configured to define multiple waveguides that extend through the thickness dimension and have respective ends at the first and second major surfaces, wherein at least some of the waveguides being at least partially transmissive to the desired wavelength of EUV radiation. An EUV-transmissive layer can be situated on the second major surface, wherein the EUV-transmissive layer is at least partially transmissive to the desired wavelength and covers at least some of the ends of the waveguides on the second major surface. A reflective layer can be situated on the first major surface, wherein the reflective layer is reflective to at least a first portion of the out-of-band radiation. The waveguides desirably are configured to attenuate at least a second portion of the out-of-band radiation entering the waveguides from the first major surface. In certain embodiments the first major surface is substantially planar, wherein the cooling device is configured to direct a heat-conduction medium to at least the first major surface in the second filter region. In addition or alternatively, the second major surface can be substantially planar, wherein the cooling device is further configured to direct a heat-conduction medium to at least the second major surface in the second filter region.

According to another aspect, EUV SPFs are provided for placement downstream of an EUV source that produces a desired wavelength of EUV radiation as well as out-of-band radiation. An embodiment of such an SPF comprises a substrate having a first major surface facing upstream generally toward the EUV source, a second major surface facing generally downstream, and a thickness between the major surfaces. The substrate desirably defines multiple waveguides that extend through the thickness and have respective ends at the first and second major surfaces. The waveguides are at least partially transmissive to the desired wavelength of EUV radiation. The second major surface includes an EUV-transmissive layer. The EUV-transmissive layer is at least partially transmissive to the desired wavelength and covers at least some of the waveguide openings at the second major surface. The first major surface includes a reflective layer that exhibits reflectivity to at least a first portion of the out-of-band radiation so as to prevent the first portion from entering the substrate. Respective portions of the reflective layer can extend into the waveguides from the first major surface. The waveguides desirably attenuate at least a second portion of the out-of-band radiation entering the waveguides from the first major surface, so as to reduce the second portion passing through the waveguides to the EUV-transmissive layer.

In certain embodiments of these EUV SPFs, the substrate is silicon, the EUV-transmissive layer comprises SiO₂, and the reflective layer comprises a metal. Exemplary metals are Zr and Nb.

The EUV-transmissive layer can be configured to extend planarly over the openings of the waveguides on the second major surface. Alternatively, or in addition, the EUV-transmissive layer can comprise respective non-planar shells covering the openings of the waveguides on the second major surface.

In certain embodiments the waveguides are in a regular array. In other embodiments the waveguides have round transverse profiles. In other embodiments the waveguides have rectilinear transverse profiles. In yet other embodiments the waveguides have slot-shaped transverse profiles. Slot-shaped waveguides can include a first group of which the respective slot-shaped transverse profiles extend in a first direction and a second group of which the respective slot-shaped profiles extend in a second direction that is substantially orthogonal to the first direction. By way of example in such a configuration, the substrate can comprise a downstream portion and an upstream portion that are substantially parallel to each other. The waveguides of the first group can be defined in and extend through a thickness dimension of the upstream portion of the substrate, and the waveguides of the second group can be defined in and extend through a thickness dimension of the downstream portion of the substrate. The upstream and downstream portions of the substrate can be bonded to each other. If the upstream and downstream portions have respective struts, the portions can be bonded to each other strut-to-strut.

According to yet another aspect, optical systems are provided. An embodiment comprises a first chamber that contains a radiation source that produces a beam of electromagnetic radiation, and a second chamber that is situated relative to the source chamber. The system includes a propagation pathway for the beam from the first chamber to the second chamber. A filter element, comprising multiple selectable filter regions, is situated relative to the propagation pathway such that the beam can impinge on a selected filter region to transmit a first wavelength of the electromagnetic radiation through the filter element while limiting transmission of a second wavelength of the electromagnetic radiation. An actuator is coupled to the filter element and is configured to move the filter element to place a first filter region relative to the propagation pathway for impingement by the beam while moving a second filter region of the filter element away from the propagation pathway. A cooling device is situated and configured to direct contact of a heat-conduction medium with at least the second filter region. Certain embodiments can include a wall that at least partially separates the second chamber from the first chamber. The wall, if present, can define the propagation pathway as well as an inner chamber that contains the filter element and in which the filter element moves by the actuator, relative to the propagation pathway.

The heat-conduction medium can be a gas, wherein the cooling device comprises a gas-film-producing device that directs, in the inner chamber, a flow of a film of the gas to at least the second filter region. The cooling device further can comprise a gas-recovery device that is situated and configured to recover, in the inner chamber, at least some of the gas that has been directed to at least the second filter region. By way of example, the gas-recovery device can surround the gas-film-producing device.

In these optical-system embodiments the filter element can be configured as an EUV spectral purity filter element in a manner, for example, as summarized earlier above.

Another embodiment of an optical system comprises radiation-source means for producing a beam of electromagnetic radiation, first chamber means for containing the radiation-source means, second chamber means located downstream of the first chamber means, propagation-pathway means for passing the beam from the first chamber to the second chamber, filter means, actuator means, and cooling means. The filter-element means provides multiple selectable filter regions relative to the propagation-pathway means such that the beam can impinge on a selected filter region to transmit a first wavelength of the electromagnetic radiation through the filter element and propagation-pathway means and to attenuate transmission of a second wavelength of the electromagnetic radiation. The actuator means is for moving the filter element and placing a first filter region relative to the propagation-path means for impingement by the beam while moving a second filter region of the filter element away from the propagation-path means. The cooling means is for directing a heat-conductive medium at the second filter region for removing heat from at least the second filter region.

According to yet another aspect, methods are provided for removing heat from a filter element that receives a beam electromagnetic radiation and transmits a first wavelength of the electromagnetic radiation while limiting transmission of a second wavelength of the electromagnetic radiation. An embodiment of such a method comprises configuring the filter element with multiple filter regions that are selectable, by moving the filter element, for receiving the beam of electromagnetic radiation. After irradiating a selected filter region with the beam of electromagnetic radiation, the filter element is moved so as to move the filter region away from being irradiated by the beam. A heat-conductive medium is directed at the moved filter region so as to cool the moved filter region. The step of directing the heat-conductive medium can comprise directing flow of a film of gas to the filter region that has been moved away from the beam. The method further can comprise recovering the gas directed at the filter region.

Also provided are various optical systems that include filter apparatus or SPFs as summarized above. Such optical systems can be EUV optical systems. Also provided are lithography systems (e.g., EUV lithography systems) that comprise such optical systems. The foregoing and additional features and advantages of the subject apparatus and methods will be more readily apparent from the following detailed description, which proceeds with reference to the accompanying drawings.

### BRIEF DESCRIPTION OF THE DRAWINGS

FIG. 1 is a sectional view depicting details of a first representative embodiment of a spectral purity filter (SPF) device that rotates.

FIG. 2 depicts an exemplary manner of cooling the SPF of FIG. 1, by rotating the filter through a cooling zone.

FIG. 3(A) is a sectional view showing details of an embodiment of an SPF device that comprises one gas-film-producing device for cooling a rotational SPF.

FIG. 3(B) is an elevational section of the embodiment shown in FIG. 3(A).

FIG. 3(C) is a sectional view showing details of an alternative configuration of a gas-film-producing device for cooling a rotational SPF.

FIG. 3(D) is a sectional view of an embodiment of an SPF device that comprises three gas-film-producing devices for cooling a rotational SPF.

FIG. 3(E) is a partial sectional view of an embodiment of an SPF device that comprises an elongated gas-film-producing device for cooling a rotational SPF.

FIG. 3(F) is a sectional view of an embodiment of an SPF device that comprises a large gas-film-producing device for cooling a rotational SPF.

FIG. 4 provides orthogonal views (one view being sectional) of an embodiment of an SPF device comprising an SPF that moves in a reciprocating manner and that is cooled by a pair of gas-film-producing devices.

FIG. 5 is a plan view of a rotational SPF that includes portions that provide functions other than SPF functions.

FIG. 6 is a plot of transmission versus wavelength, in a range up to 120 nm, for zirconium, silicon, B₅H₁₁, ZrCl₄, SiO₂, SiN₄, and carbon at specified thicknesses.

FIG. 7 is a photographic print of a portion of a surface of a silicon wafer on which a regular array of SiO₂ shells (covering respective pores extending through the thickness of the silicon) is formed, as set forth in the Schilling et al. reference cited herein.

FIG. 8 is a schematic elevational view of a portion of the filter structure shown in FIG. 7, showing exemplary pores and shells.

FIG. 9 is a plot of transmission versus wavelength of the filter structure shown in FIG. 7.

FIG. 10 is a plot of exemplary transmission versus wavelength of certain round waveguides, having a 100-nm radius as described herein, at two different distances (“z”) into the waveguide. Note, for example, that “1.E-05” is an abbreviation for 1×10⁻⁵.

FIG. 11 is a plot of exemplary attenuation, measured at the aperture of a circular waveguide 200 nm in diameter, versus wavelength as caused by impedance mismatch between the end of the waveguide and free space, where λ_{c}=400 nm.

FIG. 12 is a plot of exemplary transmission, through a slot waveguide having a width of 200 nm, versus wavelength, illustrating attenuation under TE mode conditions.

FIG. 13 is a plot of exemplary attenuation, exhibited by a 200-nm slot waveguide, versus wavelength, illustrating the effect of radiation loss at the end of the waveguide for wavelengths greater than the slot width.

FIG. 14 is a plot of transmission, through 60-nm thick films of SiO₂, SiN₄, and diamond-like carbon (DLC), versus wavelength in a range up to 400 nm.

FIGS. 15(A)-15(B) are respective orthogonal views of a portion of an embodiment of an SPF manufactured using certain techniques used in the manufacture of electron-projection-lithography (EPL) masks.

FIG. 16 is a section through a portion of another embodiment of an SPF manufactured using certain techniques used in the manufacture of EPL masks, the embodiment comprising two portions bonded together back-to-back, strut-to-strut.

FIG. 17 is a schematic view showing how two portions, which can be similar to portions shown in FIG. 16 and having respective arrays of slot waveguides oriented at right angles to each other, are bonded together.

FIG. 18 is a schematic elevational view of an EUV lithography system including a reticle-protection device as disclosed herein.

FIG. 19 is a process-flow diagram illustrating exemplary steps associated with a process for fabricating semiconductor devices.

FIG. 20 is a process-flow diagram illustrating exemplary steps associated with processing a substrate (wafer), as would be performed, for example, in step 704 in FIG. 19.

FIG. 21 is a plot of the heat-transfer properties of nitrogen gas.

FIGS. 22(A)-22(B) show respective orthogonal views of a portion of an embodiment of an SPF, the embodiment comprising two portions bonded together back-to-back, strut-to-strut. FIG. 22(A) is a section along the line A-A in FIG. 22(B), and FIG. 22(B) is the orthogonal view along the line B-B in FIG. 22(A).

### DETAILED DESCRIPTION

The following detailed description is set forth in the context of exemplary embodiments that are not intended to be limiting in any way. Also, although the description below is made in the context of EUV light and EUV optics, it will be understood that the disclosed apparatus and methods can be used with other radiation, including other wavelengths of electromagnetic radiation.

SPF-Cooling Devices

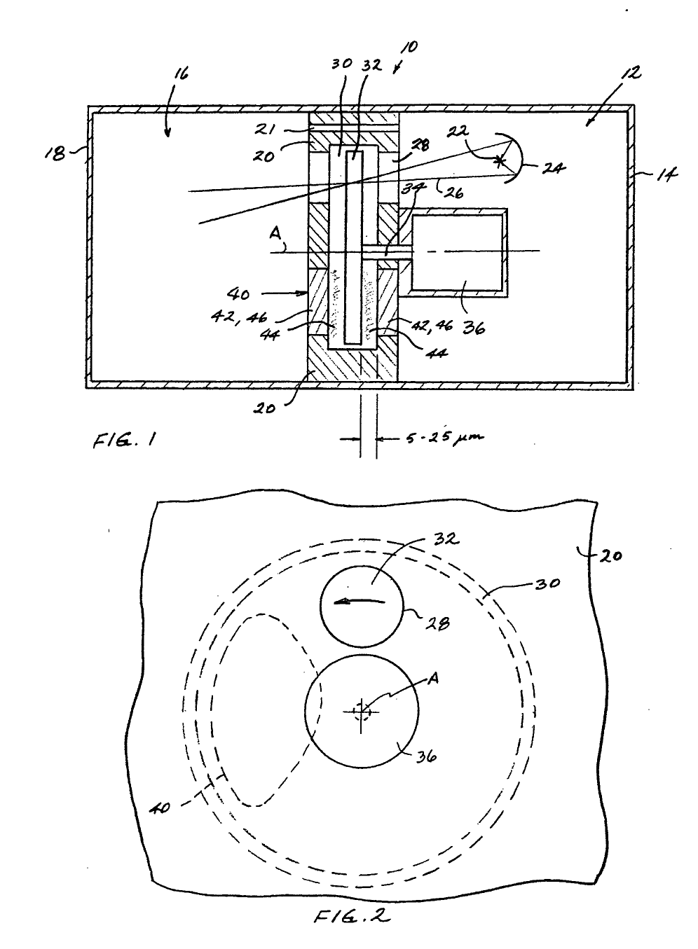

An exemplary embodiment 10 of an SPF-cooling device is shown in FIG. 1, which depicts an EUV-source chamber 12 defined by respective walls 14, and an illumination-unit chamber 16 defined by respective walls 18. The EUV-source chamber 12 is separated from the illumination-unit chamber 16 by a dividing wall 20. In the EUV-source chamber 12 EUV light is produced, e.g., from a plasma 22. Light emanating from the plasma 22 is gathered into a beam by a collector mirror 24 (or analogous appliance) that directs the beam 26 in a convergent manner toward an opening 28 (serving as a “window”) defined in the dividing wall 20. The opening 28 provides a propagation pathway for the beam 26 from the EUV-source chamber 12 to the illumination-unit chamber 16.

The dividing wall 20 also defines, in the depicted embodiment, an inner chamber 30 that is sized and shaped to house a spectral purity filter (SPF) 32 as a representative filter element. In this embodiment the SPF 32 is shaped as a circular disc having a rotational axis A. The inner chamber 30 is configured so as to allow rotation of the SPF 32 about the axis A. By way of example and not intending to be limiting, the gap between a face of the SPF 32 and the facing wall of the inner chamber 30 is 5-25 μm. To rotate the SPF 32 a shaft 34 extends along the axis A and is attached to the SPF. The shaft 34 is rotatable about the axis A by a motor 36 or analogous device that is driven so as to rotate the shaft 34, and thus the SPF 32, during use of the SPF. Rotation can be continuous, intermittent, or periodic. The motor 36 can be, for example, a brushless DC motor or stepper motor. As the SPF 32 rotates during use, the beam 26 impinges on the SPF. Due to rotation of the SPF 32, the portion of the SPF actually being irradiated at a given instant by the beam 26 changes, which prevents any portion of the SPF 32 from being continuously irradiated (at least for any significant length of time) and substantially slows the rate of heat accumulation in that portion of the SPF. In this regard, the SPF 32 can be regarded as having multiple filter regions (which can be continuous or discontinuous); by rotating the SPF 32, a selected filter region is moved into registration with the opening 28 where the selected region can be irradiated by the beam 26.

For pressure equalization between the EUV-source chamber 12 and the illumination-unit chamber 16, it is desirable to provide the dividing wall 20 with a bleed hole 21 to prevent damaging the SPF 32. The bleed hole can be valved if desired (not shown) such as with a check valve. Alternatively to providing the bleed hole 21 in the dividing wall 20, a bleed hole can be defined in the SPF 32. Further alternatively, both the dividing wall 20 and the SPF 32 can have respective bleed holes.

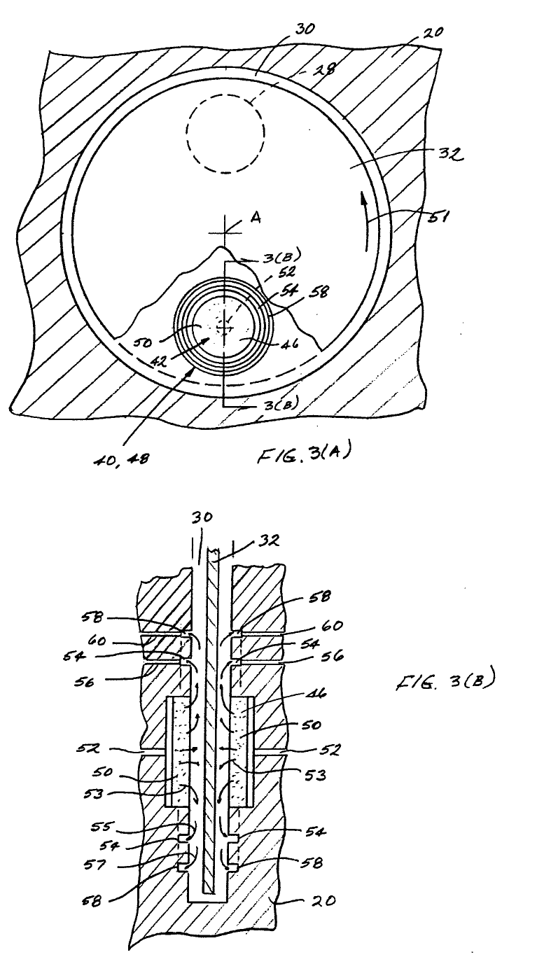

Desirably, as the SPF 32 rotates, portions of the SPF that are not in the beam path are cooled, e.g., by conduction using a heat-conduction medium and a heat sink. Referring to FIG. 2, an advantageous manner of cooling the SPF 32 by conduction is by providing at least one cooling zone 40 within the inner chamber 30 and rotating the SPF through the cooling zone. The cooling zone 40 advantageously is located so that the portion of the SPF 32 just contacted by the beam 26 is moved promptly into the cooling zone so that heat absorbed by the SPF is rapidly removed from the SPF by the cooling zone. The cooling zone 40 can be configured to provide, for example, a gas film (as an exemplary heat-conduction medium) in the gap between the SPF 32 and the facing wall of the inner chamber 30. (The gap desirably is very thin, for example approximately 5-25 μm in certain embodiments. This enhances the heat transfer property of the gas and can prevent significant amounts of the gas from degrading the vacuum in either or both the EUV-source chamber 12 and illumination-unit chamber 16.) The gas used for forming the film can be, for example, the ambient gas present in the EUV-source chamber 12 and illumination-unit chamber 16. As the just-irradiated portion of the SPF 32 is moved into the cooling zone 40, the gas film contacts the just-irradiated portion and removes heat by conduction from the just-irradiated portion to a heat sink (see below) in the cooling zone 40, such that the gas film is situated between the just-irradiated portion of the SPF 32 and the heat sink.

In another embodiment, returning to FIG. 1, the cooling zone 40 comprises a gas-film-producing device 42 that directs flow of a film of gas 44 to the SPF 32 so as to impinge on the SPF and remove heat from the SPF and conduct it to a heat sink 46. An exemplary gas for this purpose is helium (He), which has a very high thermal conductivity. Alternatively, another of the noble gases can be used, or a mixture of noble gases. Further alternatively, the gas can be nitrogen gas or other suitable “system” gas, or mixture of such gases, or mixture of one or more of such gases with one or more noble gases. The gas with the highest thermal conductivity is hydrogen. The cooling zone 40 includes a heat sink 46 that is contacted by the gas 44 to transfer heat through the gas 44 from the SPF 32 to the heat sink 46. The heat sink 46 can be simply a region of the wall of the inner chamber 30 facing the SPF 32. The heat sink 46 can be cooled with a coolant (e.g., liquid or gaseous coolant) that is circulated for example through interior conduits (not shown) and that is temperature-controlled by conventional means. As described below, the cooling zone 40 can include a gas-recovery device for removing the gas 44 (after the gas has contacted the SPF 32) and thus preventing significant amounts of the gas from entering either the illumination-unit chamber 16 or the EUV-source chamber 12.

The heat-transfer properties of the gas depend on the type of gas, the gap separating the SPF 32 surface from the heat sink 46 surface, and the gas pressure. FIG. 21 shows the heat transfer of nitrogen gas at a temperature of 300° K for a range of pressures and gaps. The heat transfer was calculated from the theory described in Wright et al., J. Vac. Sci. Technol., A10:1065, 1992. For maximum heat transfer, higher gas pressures and smaller gaps are clearly preferred. However, higher gas pressures may be precluded by system vacuum level requirements. While heat may be transferred from the SPF to a flowing gas, and thus carried away, the heat capacity of gases used under the present conditions is extremely small. In addition, radiative heat transfer from the SPF to cooler surroundings is inadequate under the present conditions. Thus, heat conduction from the SPF to a heat sink is practically the only means of heat removal from the SPF.

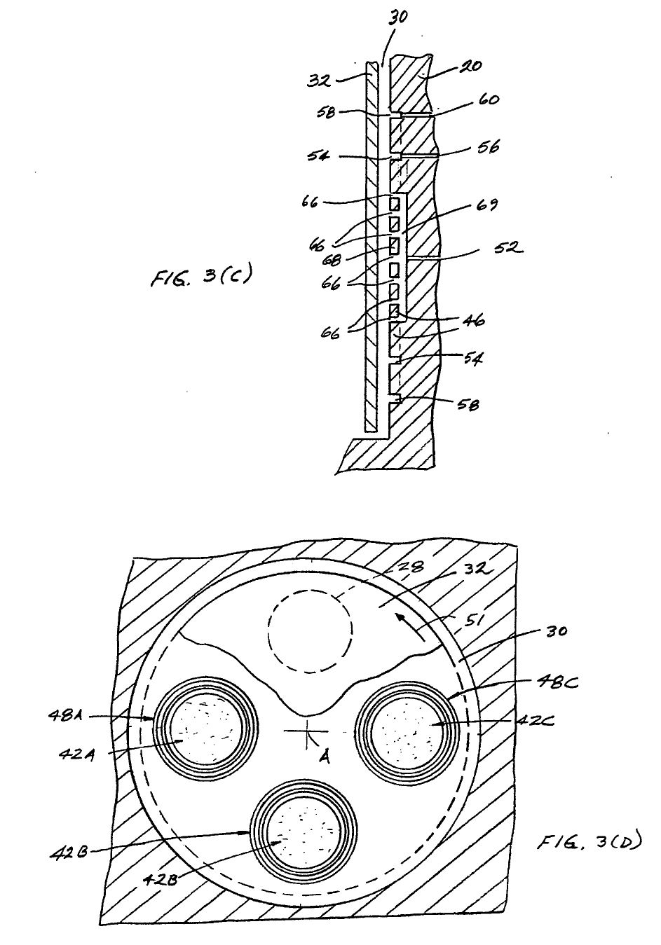

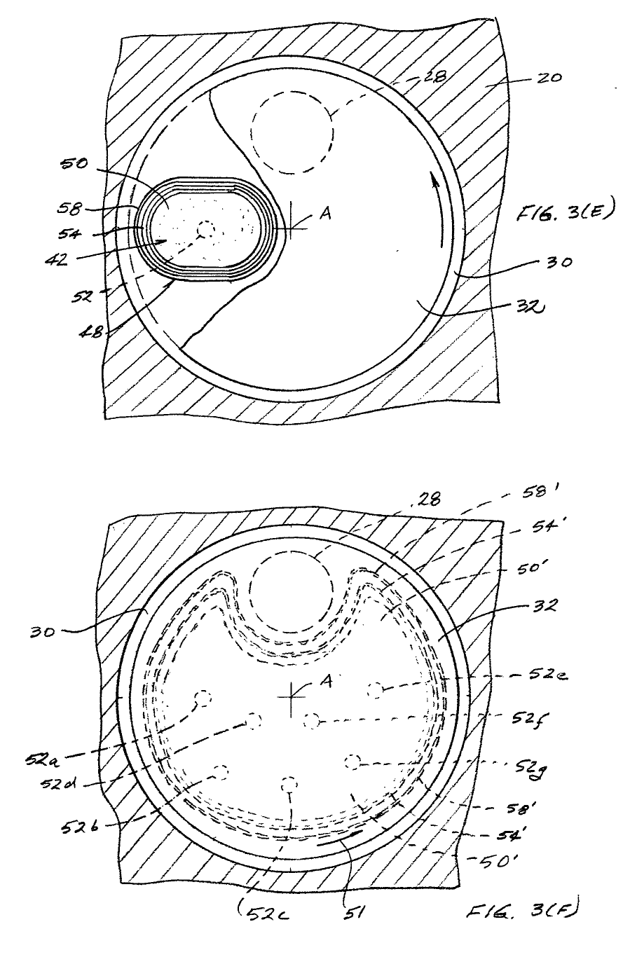

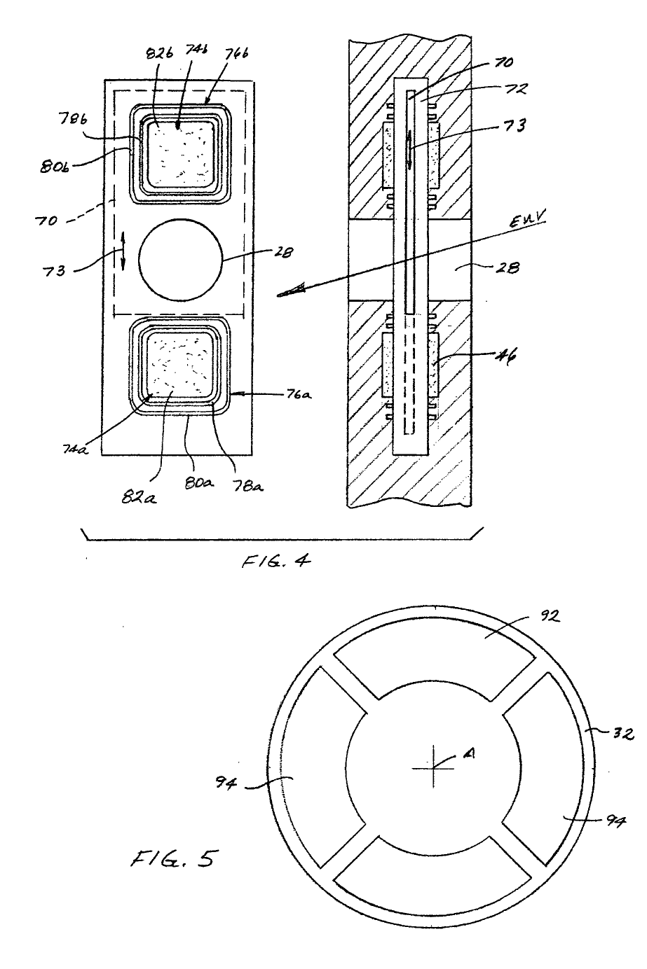

More specific details of a gas-film-producing device 42, in an embodiment that includes a gas-recovery device 48, are shown in FIGS. 3(A)-3(B). In the depicted embodiment, the cooling zone 40 is located rotationally downstream of the opening 28 (note arrow 51 denoting rotation of the SPF 32) on both sides of the SPF. The gas-film-producing device 42 in this embodiment faces both sides of the SPF 32. On each side of the SPF 32, the gas-film-producing device 42 comprises a gas-porous region 50 (e.g., a disc-shaped region). Gas delivered by a conduit 52 passes through the gas-porous region 50 (note arrows 53) toward the respective side of the SPF (see FIG. 3(B)) so as to impinge on the SPF 32 and thus conduct heat from the SPF to a heat sink 46. The gas-porous region 50 is surrounded by the gas-recovery device 48, which is configured to prevent significant amounts of gas, discharged from the gas-film-producing device 42, from escaping to the either or both of the chambers 12, 16. The gas-recovery device 48 in this embodiment comprises a first groove 54 that surrounds the gas-porous region 50, collects the gas (note arrows 55) released by the gas-porous region 50, and vents the collected gas (via the conduit 56) to a vacuum pump, or to atmosphere in the event that the gas pressure in the cooling zone 40 exceeds an atmosphere. The gas-recovery device 48 of this embodiment may also comprise a second groove 58 that surrounds the first groove 54 and collects (note arrows 57) remaining gas, not collected by the first groove 54, and routes the collected gas to a vacuum pump via the conduit 60. On the other hand, in certain embodiments, the gas-recovery device 48 may include only one groove that can be used for venting to a vacuum pump.

Turning now to FIG. 3(C), as an alternative to the porous disc 50, gas can be discharged toward the SPF 32 via small openings 66 defined in a plate 68 covering a plenum 69 supplied with gas from a conduit 52. In FIG. 3(C), even though only the gas-film-producing device on the right side of the SPF 32 is shown, it will be understood that a similar gas-film-producing device also can be located on the left side of the SPF. The second gas-film-producing device that would be present on the left side desirably is configured as a mirror image of the gas-film-producing device depicted on the right side. With the exception of the manner in which gas passes from the conduit 52 to the SPF 32, the configuration of the gas-film-producing device shown in FIG. 3(C) functions similarly to the configuration shown in FIG. 3(B). An embodiment utilizing a gas-film-producing device on only one side of the SPF may have advantages in some circumstances. However, placing gas-film-producing devices on both sides of the SPF not only doubles the possible heat transfer of the embodiment, but allows higher gas pressures, and thus higher heat transfers, than a single-sided gas-film-producing device. In the latter case, the fragility of the thin-film SPF would likely limit the maximum gas pressure that could be tolerated.

Whereas FIG. 3(A) shows only one gas-film-producing device 42 and one gas-recovery device 48 (each having a respective portion located on each side of the SPF), multiple gas-film-producing devices and gas-recovery devices alternatively can be employed. For example, FIG. 3(D) depicts three gas-film-producing devices 42A, 42B, 42C and three corresponding gas-recovery devices 48A, 48B, 48C situated at respective locations around the SPF 32 relative to the opening 28. Each of the gas-film-producing devices 42A-42C and gas-recovery devices 48A-48C functions similarly to the gas-film-producing device 42 and gas-recovery device 48, respectively, shown in FIG. 3(A). Although each gas-film-producing device 42A-42C has a corresponding gas-recovery device 48A-48C, it will be understood that not all gas-film-producing devices in an arrangement of multiple such devices have a corresponding gas-recovery device. For example, a single gas-recovery device can be used for scavenging gas released from multiple gas-film-producing devices.

The gas-film-producing device 42 and gas-recovery device 48 need not have the depicted round profiles. For example, in FIG. 3(E), these devices 42, 48 can be oblong, e.g., elongated in a direction of a radius of the SPF 32. Alternatively, as shown in FIG. 3(F), a gas-film-producing device 42 can be sized and shaped so as to encompass a large area of the SPF 32. As indicated by the dashed lines 50′, 54′, 58′, these devices 42, 48 can be sized and shaped so as to encompass a maximal area of the SPF 32.

Although the embodiments of FIGS. 3(A)-3(F) depict an SPF 32 that rotates about the axis A, other schemes for moving the SPF can be employed. For example, FIG. 4 depicts an SPF 70 that moves in a reciprocating manner in the inner chamber 72 (up and down in the figure, as denoted by the arrow 73) relative to the opening 28 for the EUV beam. The reciprocating motion can be imparted by a rotary motor linked to the SPF 70 in a manner that converts rotary motion of the motor to reciprocating motion, in which event the SPF 70 can be supported by a flexural bearing, for example, rather than a rotary bearing as would be used in the embodiment of FIG. 1. Alternatively, the SPF 70 can be coupled to a linear motor, for example. Even though the figure depicts up and down motion (arrow 73), it will be understood that the motion alternatively can be sideways (into and out of the plane of the page) or any combination of directions.

In the depicted embodiment, two gas-film-producing devices 74a, 74b and two respective gas-recovery devices 76a, 76b are shown. Each gas-film-producing device 74a, 74b includes a respective gas-porous region 82a, 82b through which gas is discharged toward the surface of the SPF 32. In this embodiment each gas-film-producing device 74a, 74b has respective portions located adjacent each side of the SPF 70, as shown in the right-hand portion of FIG. 4. Each gas-recovery device 76a, 76b has respective portions located adjacent each side of the SPF 70. The gas-recovery devices 76a, 76b include respective first vacuum-venting grooves 78a, 78b and respective second vacuum-venting grooves 80a, 80b in surrounding relationship to the respective gas-porous regions 82a, 82b. On the other hand, in certain embodiments, the gas-recovery device 76a, 76b may include only one groove that can be used for venting to a vacuum pump. If desired or necessary, gas delivery to the gas-porous regions 82a, 82b can be timed in synchrony with motion of the SPF 70 so that gas is delivered only when the respective portion of the SPF is situated between opposing gas-porous regions. Alternatively, the SPF can be made long enough that both gas-recovery devices 76a and 76b remain sealed.

In addition to the SPF 32 having a spectral-filtration property, the SPF also can include one or more of various other functionalities. For example, the SPF 32 (especially a disc-shaped SPF) can include not only at least one selectable SPF region 92 but also at least one selectable phosphor region 94 which exhibits phosphorescent or fluorescent behavior when irradiated by the beam of EUV radiation (see FIG. 5, for example). The phosphorescence or fluorescence can serve to “image” the beam and allow separate detection and use during set-up or calibration when adjustments of beam position may have to be performed. To such end, the phosphorescence or fluorescence can be detected, for example, by a CCD-based image sensor, which can be used for digitizing the image of the beam for analysis of beam characteristics or source quality, for example. For this purpose, the SPF desirably is located at the intermediate focal point of the beam to enable capture of a focused image of the source. The regions 92, 94 need not have the depicted shapes or relative surface areas; these parameters can be changed as needed or required.

A disc-shaped SPF can be used in a mode in which only respective regions of the disc are used for filtering and heat-transfer. After the current filtering region degrades optically with prolonged use, a fresh region of the disc can be used for filtration and heat transfer, thereby extending the time that otherwise would be required before having to replace the entire SPF, if needed.

With a rotating SPF, the rate of rotation can be un-synchronized with the EUV-beam pulses so as to minimize the effects of any defects in the SPF on SPF performance.

Whereas the embodiments described above effectively utilize a conventional SPF (e.g., a 100-nm thick Zr film on a Ni mesh), even greater benefits are realized using improved SPFs as described below.

SPF Filters Made Using Silicon-Processing Techniques

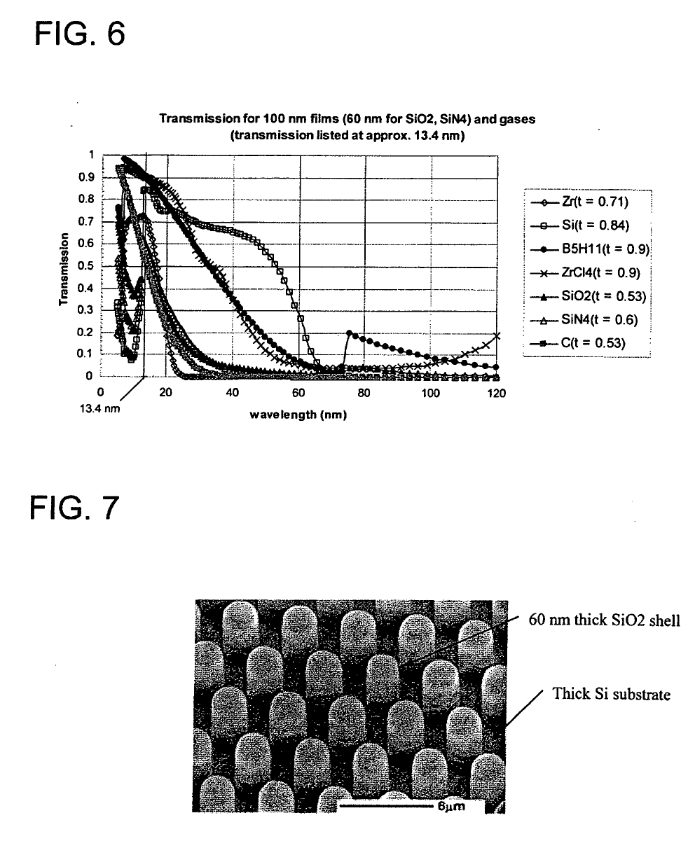

Reference is made to FIG. 6, which presents plots of radiation transmission through various films (60 and 100 nm thick, depending upon the composition of the film) and gases. As can be seen, a 100-nm thick silicon (Si) film exhibits greater transmission to 13.4-nm EUV light than a 100-nm thick film of Zr, but the Si film also transmits more longer wavelengths than the Zr film. Films (60-nm thick) of SiO₂ and SiN₄, while exhibiting somewhat lower transmission to 13.4-nm EUV light than the Zr film, exhibit better blocking of longer EUV wavelengths than Zr. Decreasing the thickness of the respective films would increase the respective transmissions exhibited by SiO₂ and SiN₄ to 13.4-nm EUV light.

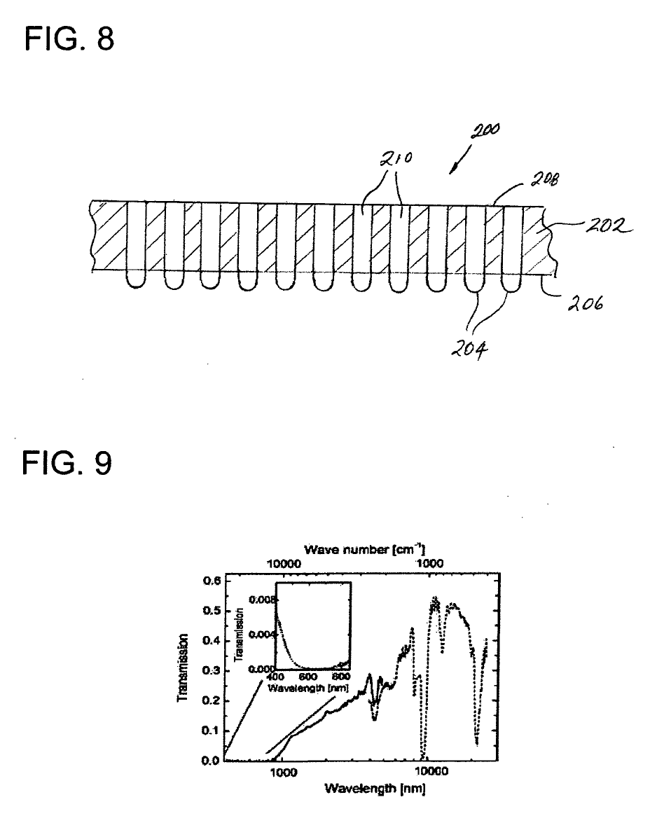

Reference is now made to FIGS. 7 and 8, which depict a structure fabricated using certain techniques as disclosed in Schilling et al., Appl. Phys. Lett. 85:1152, 2004, incorporated herein by reference. The structure 200 comprises a thick (approximately 50 μm thick) silicon wafer 202 that serves as a substrate. A regular array of 60-nm thick, hemispherical SiO₂ shells 204 have been formed on a first major surface 206 of the substrate. The opposite surface 208 of the substrate 202 is a second major surface. Each shell 204 forms a respective dome over the opening of a respective pore 210 (actually a waveguide as discussed later below) extending through the thickness of the substrate 202 and opening on the first and second major surfaces 206, 208. The shells 204 protrude from the first major surface 206 as shown schematically in FIG. 8.

Briefly, to form the structure shown in FIGS. 7 and 8, a two-dimensional hexagonal array of KOH etch pits is formed on the surface of a (100)-oriented n-type Si wafer. The etch pits serve as nucleation sites for the formation of macropores that are etched into the wafer using 5% HF at 10° C. with application of 2.8 V between a cathode and the Si wafer. To supply electronic holes for this etching step, the wafer is illuminated from the back side with visible light, and the diameter of the macropores is controlled by controlling illumination intensity. The resulting macropores are 50 μm long (extending through the thickness of the Si) and have a mean diameter of 2.46 μm, corresponding (in one example) to an average porosity of 31%. During etching, the pores increase in length perpendicularly to the wafer surface in the [100] direction. After etching, the pore walls are covered with a layer of microporous Si. To remove the microporous layer and smooth the pore walls, the structure is oxidized for 3 h at 900° C., and the resulting SiO₂ layer is etched away using HF. A final thermal oxidation performed at 900° C. for 3 h leaves a 60-nm thick SiO₂ layer on the pore walls. Finally, the bulk-silicon back-side of the wafer is removed by etching in 25% KOH at 90° C. and 25% TMAH (tetramethylammonium hydroxide). Etching is halted when the oxidized pore-heads remain. The resulting structure is a 50-μm thick macroporous Si membrane of which the ends of pores on one side of the membrane are closed by dome-shaped SiO₂ shells of the former pore-tips.

The structure shown in FIGS. 7 and 8 is sufficiently strong to withstand a pressure differential, across the membrane, of one atmosphere. This performance is achieved in part due to the particularly geometry of the shells (hemispherical), the dimensions of the shells (approximately 2.5 μm in diameter), and the thickness of the SiO₂ shells (60 nm). A pressure differential of 1 atm is much greater than would be experienced by an EUV SPF, which usually experiences a pressure differential, under vacuum conditions, of approximately 10⁻³ atm or less. Consequently, the dimensions and thickness of the shells can be manipulated to improve the porosity and transmission to 13.4-nm EUV light. For example, with SiO₂, halving the thickness can yield a substantial increase in EUV transmission (up to 80 to 90%). Hence, reducing the shell thickness from 60 nm would yield a substantial increase in transmission of the desired EUV wavelength while still providing a structure capable of supporting itself and withstanding the pressure differential normally encountered by an EUV SPF. Because decreasing the shell thickness also increases transmission of other wavelengths, including of undesired wavelengths, the optimal shell thickness is not the thinnest possible shell but rather a tradeoff thickness that exhibits acceptable transmission of the desired EUV wavelength while not exhibiting excessive transmission of undesired wavelengths and while exhibiting satisfactory mechanical strength.

With respect to the structure shown in FIGS. 7 and 8, it will be understood that appropriate changes in the fabrication process can be made to change the shell material. For example, the shells can be made of SiN₄ instead of SiO₂.

The porosity of the structure of FIGS. 7 and 8 can be selected within a wide range. (The “porosity” is the percentage of a unit surface area of the structure that is occupied by pores or analogous features, such as waveguides, that transmit the desired wavelength of incident EUV light.) In general, increasing porosity is an effective way of increasing transmission of the desired EUV wavelength (simply by increasing the relative surface area of the features that are transmissive to the desired EUV wavelength). Hence, within certain constraints such as maintenance of sufficient mechanical strength for use as an EUV SPF, higher porosity is desirable. In the structure of FIGS. 7 and 8, porosity generally is increased by increasing the total surface area of shells per unit surface area of silicon. This can be achieved, for example, by forming more pores and respective shells, in a unit area of a major surface, having a particular diameter (i.e., increasing the “packing density” of shells), by increasing the diameter of each shell while retaining the same number of shells per unit area, or a combination of these. By way of example, in certain configurations, increasing the porosity by 10% yields a significant increase in transmission of the desired EUV wavelength.

A plot of the transmission of the structure shown in FIGS. 7 and 8 to radiation in the range of approximately 400-25000 nm is shown in FIG. 9 and is taken from Schilling et al. The plot reveals that, at λ>ca. 1000 nm, the Si substrate exhibits substantial transparency. At λ<1000 nm, the exhibited transmission is mainly through the pores and shells (i.e., through SiO₂ rather than Si). Normally, transmission through SiO₂ at λ<1000 nm is significant; the low transmission actually revealed in FIG. 9 is likely due to phenomena involving the pores, such as diffraction at the pore openings and waveguide effects, as described below. Transmission attenuated by diffraction indicates that transmission in this wavelength range can be increased by increasing the diameter of the pores.

The structure of FIGS. 7 and 8 can be modified to produce greater attenuation of certain wavelengths. For example, wavelengths greater than 1000 nm can be effectively blocked by depositing a metal film on the upstream-facing major surface 208 of the Si substrate (top surface in FIG. 8). The metal film absorbs part of the radiation and reflects part of it. Exemplary metals include, but are not limited to, aluminum, tungsten, and gold. The thickness is not critical; a thickness of 100 nm would suffice. It is noted that higher porosity leaves less surface area of the Si substrate available for the metal layer, and less surface area coated with metal yields less heat load on the metal due to incident radiation. Consequently, the particular porosity for an SPF of this configuration may be selected with consideration given to the desired degree of blocking of longer wavelengths by the metal layer.

With a metal layer on the upstream-facing major surface of the substrate, residual transmission through the pores and SiO₂ shells can be largely eliminated for many wavelengths by adjusting the diameter of the pores (assuming the radiation is incident on the major surface 208 opposite the shells). Reducing pore diameter facilitates attenuation of radiation within the pores before the radiation reaches the shells, which affords some protection for the shells to incident radiation. This attenuation arises because the pores act like respective waveguides.

With respect to the waveguide-attenuation behavior of the pores, making the walls of the pores electrically conductive causes the pores to attenuate exponentially radiation, having a wavelength λ>λ_{c} (wherein λ_{c} is a cutoff wavelength), propagating within the pores. For a circular waveguide of diameter “d”, the cutoff wavelength λ_{c} for the longest propagating mode is given approximately by λ_{c}=πd/2.4. (Thus, for example, in FIG. 7 in which the shells are approximately 2.4 μm in diameter, λ_{c}=π(2.4/2.4)=π. Hence, wavelengths shorter than about 3 μm would not be attenuated by the waveguide behavior of the pores.) For λ>λ_{c}, the radiation is attenuated by the factor exp[−2γz] in a distance z along the waveguide, where γ is the attenuation factor:
γ=2π/λ[(λ/λ_{c})²−1]^{1/2} (1)
Thus, for a given λ>λc, if λ_{c} is decreased, the attenuation factor γ increases.

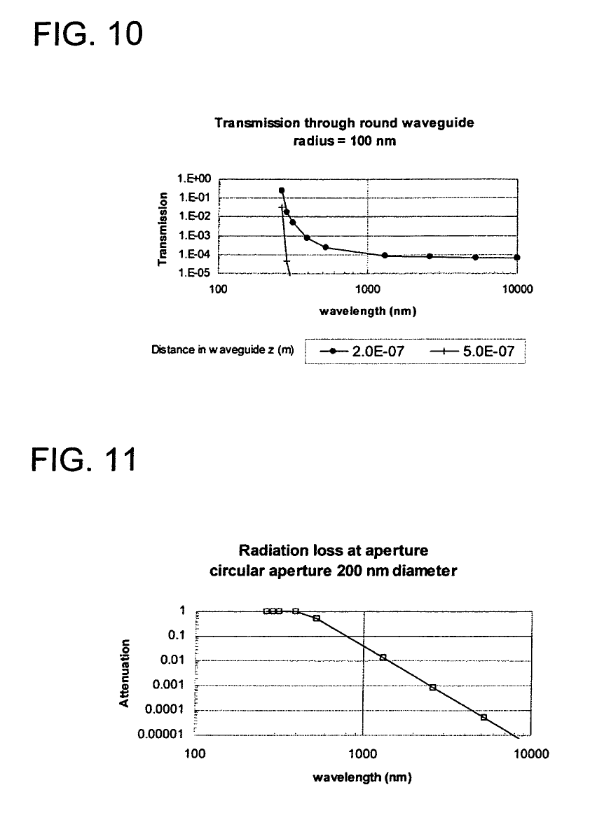

FIG. 10 depicts attenuation in a round waveguide having d=200 nm and z=200 nm (=2×10⁻⁷ m) or 500 nm (=5×10⁻⁷ m). The figure shows that the waveguide achieves substantial attenuation of wavelengths greater than λ_{c}=262 nm.

As noted above, waveguide-attenuation is facilitated by the walls of the waveguide being electrically conductive, so that the electric field of electromagnetic radiation entering the waveguide goes to zero at the wall. Thus, a thin coating of SiO₂ (which is a dielectric) on a Si pore wall will likely change the value of λ_{c}. If the conductivity of the Si substrate is too low, then a thin layer of metal can be deposited on the pore wall. Given the rate of attenuation, this metal layer would only have to penetrate a fraction of a micron into the pore to be effective. Conveniently, the metal in the pores can be the same metal used for coating the upstream-facing surface of the filter, and applying the metal in the pores can be done at the same time as coating the upstream-facing surface. The depth of penetration of the metal into the pores normally is a function of the pore diameter (aspect ratio) and of the particular deposition tool that is employed.

Waveguide-based attenuation as described above does not fully account for the power of incident energy actually dissipated in the filter. Much incident radiation simply is reflected back out of the filter, although for finite-conductivity pore walls there may be some resistive losses from this radiation. In any event, the attenuation effects can be exploited to prevent transmission of many longer wavelengths of incident EUV radiation while allowing transmission of the desired EUV wavelength.

Another waveguide-based attenuation effect arises basically from an impedance mismatch between the end (opening) of the waveguide and adjacent free space. This mismatch makes it difficult for radiation with wavelengths greater than the waveguide diameter to radiate from the end. This effect is shown in FIG. 11.

In addition to the effects described above are attenuations arising from diffraction. Diffraction can be significant for wavelengths near λ_{c}. But, for λ<<λ_{c}, diffraction effects are negligible. Consequently, for λ<λ_{c}, transmission through an SPF having a structure as shown in FIG. 8 is limited largely by the transmission properties of the SiO₂ shells.

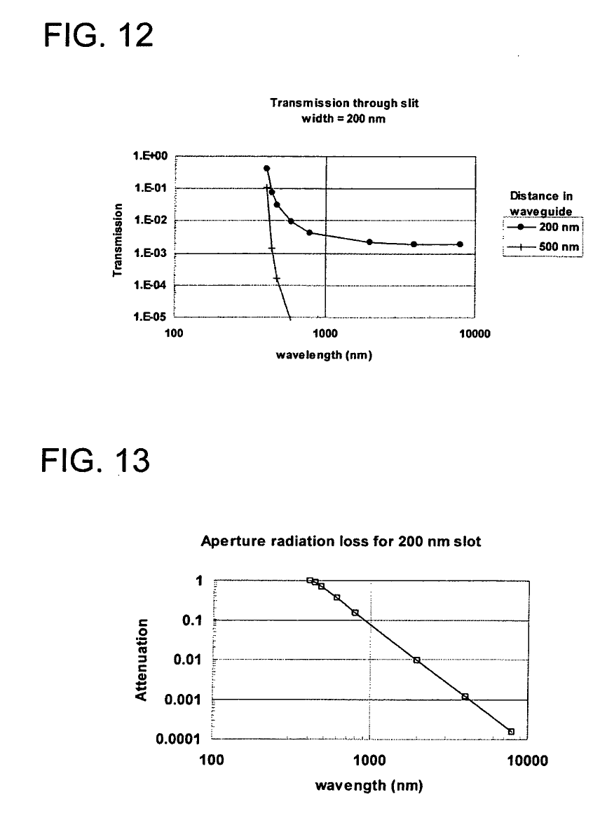

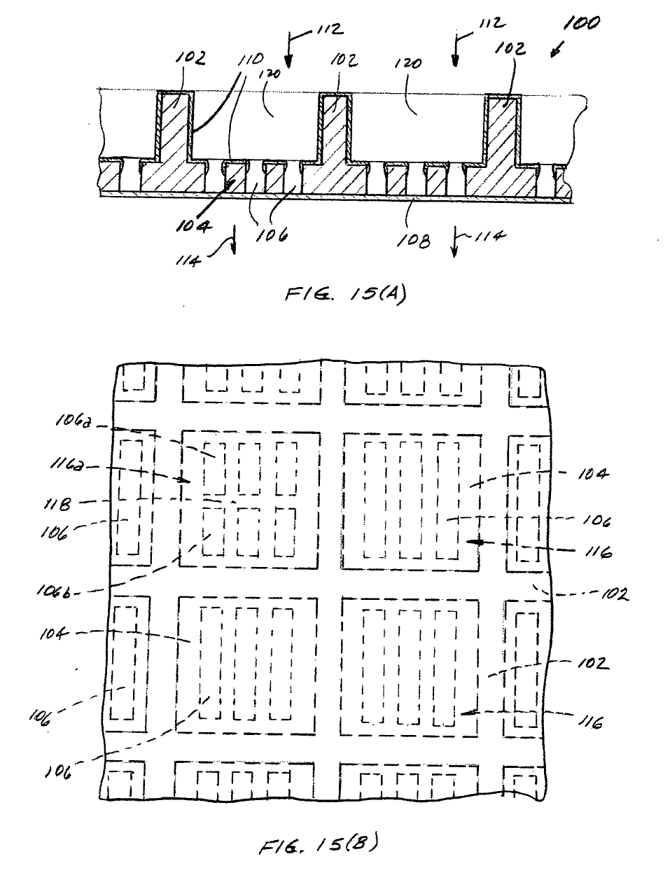

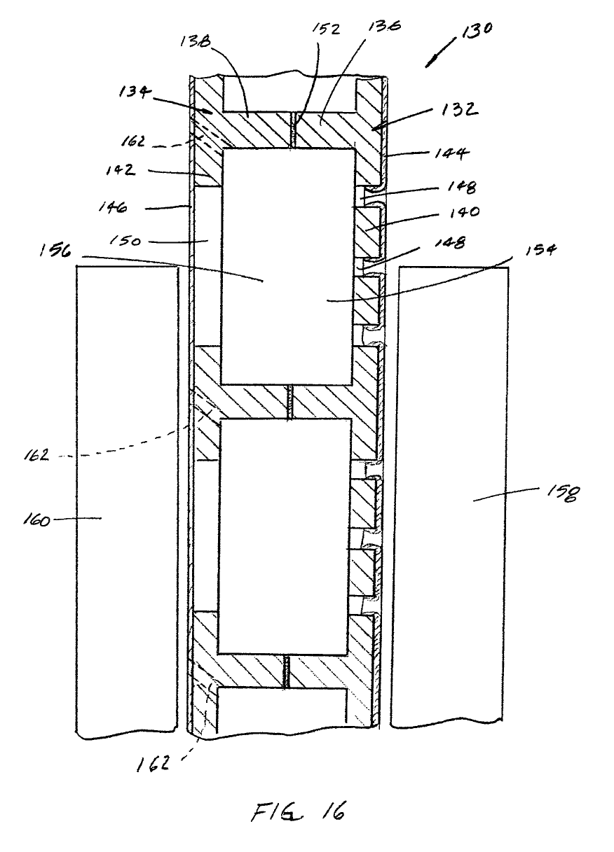

The discussion above pertained to waveguides having round transverse profiles. These waveguide-based attenuations also are applicable to waveguides having rectilinear transverse profiles. In such a rectilinear waveguide, if the transverse dimensions of the waveguide are approximately equal to each other (i.e., if the transverse profile of the waveguide is substantially square), then the attenuation behavior exhibited by the waveguide will be similar to that for a circular waveguide. However, if a first transverse dimension “a” of a waveguide is much greater than a second transverse dimension “b” (representative of a slot-type waveguide), then radiation in which the electric field is parallel to the long sides of the waveguide (TE mode) will be attenuated as described in Equation (1), where the critical wavelength is now given by λ_{c}=2b. Meanwhile, radiation in which the magnetic field is parallel to the long sides (TM mode) will be transmitted with essentially no loss in the waveguide. Waveguide-based attenuation exhibited by a slot-type waveguide of which b=200 nm (λ_{c}=400 nm) is shown in FIG. 12, for the TE mode. The slot also exhibits a radiation loss at the end (opening) of the waveguide for wavelengths greater than the slot width, as shown in FIG. 13.

Since radiation from a typical EUV source is not polarized, a slot-type waveguide only attenuates one polarization component. To attenuate both polarization components, two-slot arrays (in which the respective slots of each waveguide are oriented at right angles to each other) can be used for attenuating both polarizations equally. Alternatively, the relative orientations of the slits can be manipulated (such that the slots are at relative angles other than 90°) as desired to achieve a desired polarization performance.

Therefore, waveguide-attenuation effects can be exploited to prevent significant transmission, through the EUV SPF, of many wavelengths of incident radiation from the EUV source. These attenuation effects are especially effective in removing longer wavelengths of light while exhibiting substantially no adverse effect on the desired wavelength of EUV light. In addition, the EUV SPF can be configured having the general configuration as shown in FIG. 8, but in which the particular filtering effect exhibited by the SPF is tailored by manipulating such factors as presence or absence of a metal layer on the upstream-facing surface, porosity, pore diameter, shell thickness, presence or absence of a metal layer extending at least part way along the length of the pores, and pore geometry.

Alternatively to the filter configuration and fabrication process described above, EUV SPFs also can be constructed using a technique similar to that used for fabricating masks or reticles for electron-beam projection microlithography (EPL) as described, for example, in Reu et al., J. Vac. Sci. Technol. B20:3053, 2002; and Wood et al., J. Vac. Sci. Technol. B22:3072, 2004, both incorporated herein by reference. Slot-shaped waveguides fabricated using this technology may have some advantages over circular waveguides. For example, membrane layers can be formed of any of various materials, such as SiN₄, SiO₂, and diamond-like carbon (DLC). Also, considerable latitude is available with respect to membrane thickness, and the membranes can be made much thinner than 60 nm (or thicker if desired). Consequently, it is possible to achieve better transmission to 13.4-nm EUV light than exhibited by, for example, a Zr film. Furthermore, the better transmission is achieved with a filter wheel which is more robust and homogeneous than a thin metal film such as Zr.

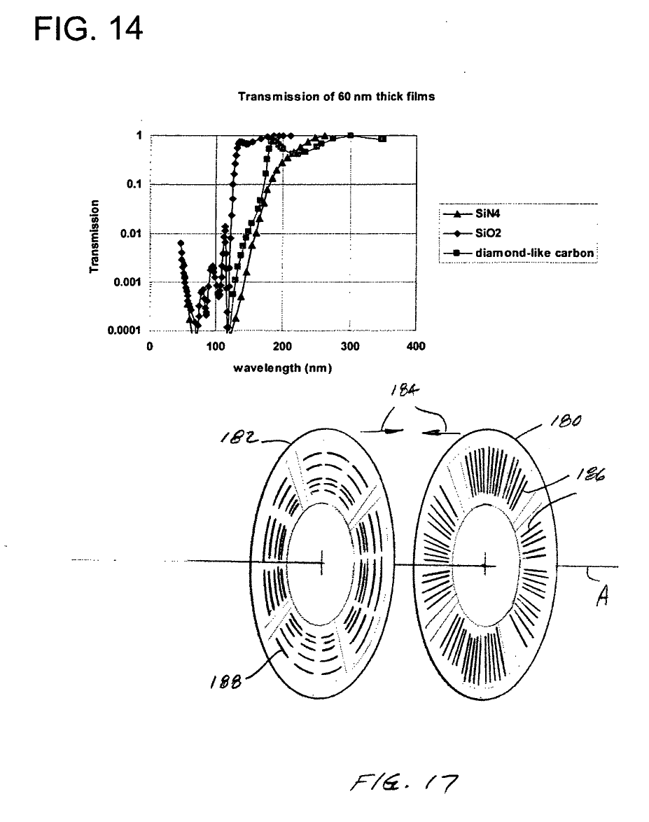

FIG. 14 is a plot of the respective transmission of thin membranes of SiO₂, SiN₄, and DLC in the vacuum ultraviolet (VUV) to the deep ultraviolet (DUV) range. SiN₄ and DLC exhibit less transmission than SiO₂, but all three membranes are transmissive to wavelengths greater than approximately 120 nm (SiO₂) to approximately 150 nm (SiN₄ and DLC). For pore or slot dimensions noted above, these data indicate that this filter has a relatively high transmission for DUV radiation within a window of approximately several hundred nm, until waveguide attenuation becomes important. This window can be narrowed by reducing the pore or slot dimensions.

Reference is now made to FIGS. 15(A) and 15(B), which depict a representative embodiment of an SPF made by EPL mask-fabrication methods. As shown in FIG. 15(A), the SPF 100 is fabricated from a Si wafer and includes Si struts 102 that define voids between them. Spanning between the struts 102 is a membrane 104 that, in the depicted embodiment, defines slotted waveguides 106 extending through the thickness dimension of the membrane 104. The membrane 104 and struts 102 constitute the “substrate” in this embodiment. Extending over the surface of the membrane 104 on the downstream side is a layer 108 of an EUV-transmissive material such as SiO₂, SiN₄, or DLC. Applied over the surface of the membrane 104 and struts 102, and facing upstream, is a reflective-metal layer 110. Note that some of the metal extends depthwise into the slots 106 in this embodiment, as discussed earlier above. Radiation (arrows 112) from the EUV source is incident on the strut side, and filtered radiation (arrows 114) exits the membrane side of the filter. In FIG. 15(B) the regular arrangement of struts 102 is shown, with membrane areas 104 extending between the struts. Each membrane area 104 is effectively a respective “subfield” 116 surrounded by respective struts 102. In this figure, the slotted waveguides 106 defined in the membrane 104 are oriented vertically in each subfield 116. In most of the depicted subfields 116, the slotted waveguides 106 extend nearly the full width of the subfield, with respective portions of the membrane 104 flanking the waveguides. By way of example, in one subfield 116a, each slotted waveguide is divided into two half-portions 106a, 106b to provide additional membrane regions 118 that add stiffness to the membrane 104. This can be the waveguide configuration in all or some of the subfields in various embodiments.

Thus, in this embodiment of an SPF, a membrane 104 comprising two film layers (i.e., the layer of silicon, with slotted or other waveguides or pores, extending between the struts 102 and the layer 108) provide the required filtering action, while other portions of the filter structure (e.g., struts and the like) provide mechanical strength. Bulk Si and waveguide structures made of Si absorb and reflect significant amounts of radiation. Reflection reduces the heat load on the thin membrane films from the surrounding support structures, allowing the filter as a whole to withstand higher power levels. Reflection permits the use of thinner films, with consequent higher EUV transmission and greater EUVL throughput.

The large attenuations of IR wavelengths by these filters provide latitude in the selection of the laser used in the laser-plasma EUV source. For generating the plasma in the laser-plasma source, CO₂ lasers have been proposed, in view of their high efficiency and commercial availability. However, the 10.6-nm wavelength produced by such a laser would be expected to exhibit significant reflectivity from the mirrors of downstream optical systems. Since laser power in commercial EUV lithography systems likely will be in the tens of kilowatts, even a small fraction of CO₂-laser radiation getting into downstream optics may damage either the reticle or the wafer. Because of the fragility of prior-art SPFs, small holes or cracks may develop in the filter during use. These holes or cracks have little consequence as far as leakage of the plasma radiation is concerned, but they can pass harmful amounts of CO₂-laser radiation. SPF filters made using silicon-processing techniques are more resistant to formation of holes and cracks, while offering prospects of exhibiting attenuation factors of as much as 10⁻¹⁰ at 10.6 μm. Of course, even with these filters, if the laser power is high enough, the filter itself will be damaged.

SPFs made using silicon-processing techniques, as described above, are readily cooled in the manner described earlier above. The particular configurations of these filters render them especially suitable for mounting for rotational or reciprocal motion. Since the filters are conveniently fabricated from silicon wafers, multiple filters can be patterned in a continuous circular array on a single wafer, yielding a filter wheel that can be installed directly as shown in FIG. 1, for example. Such a filter wheel would present no support struts, metal mesh, or the like that otherwise would interrupt the filter pattern during rotation of the filter wheel. Also, silicon fabrication leads to a more robust filter that would be more planar, and easier to keep planar. Similarly, a linear SPF can be fabricated for use in a reciprocating manner rather than a rotary manner, as described earlier above.

As shown in FIG. 15(A), voids 120 exist on one side of these filters between the struts 102. To minimize the possibility of significant leaks of cooling gas on the void side, the voids 120 can be reduced in size and depth while still preserving mechanical strength. In view of the high dimensional control provided by silicon processing, this SPF embodiment can be configured in which the voids are sufficiently small to prevent significant leakage. Also, if only the membrane side of the SPF filter is cooled, significant leakage is readily avoided due to the planarity of the membrane 104 and of the layer 108.

Turning to FIG. 16, double-sided cooling of planar surfaces of the SPF can be facilitated by bonding two strutted structures together “strut-to-strut” with the respective membrane sides facing outward. The depicted SPF 130 comprises two portions 132, 134 each having respective struts 136, 138 and membrane portions 140, 142. The membrane portion 140 presents a major surface that faces upstream (toward the EUV source, not shown) and includes a reflective-metal layer 144. The membrane portion 142 presents a major surface that faces downstream and includes an EUV-transmissive film 146. The membrane portion 140 defines slotted waveguides 148 that extend into and out of the plane of the page. The membrane portion 142 defines slotted waveguides 150 that extend up and down in the figure. Thus, the waveguides 148 and 150 are oriented at right angles to each other for attenuation of non-polarized incident radiation. The portions 132, 134 are bonded to each other via their respective struts 136, 138 using an adhesive 152 or analogous bonding means. Thus, the subfield voids 154, 156 face each other in the SPF structure. Note that the reflective-metal layer 144 and EUV-transmissive film 146 present respective substantially planar surfaces facing outward. Flanking these substantially planar surfaces are respective cooling zones 158, 160. Thus, both sides of the SPF 130 are cooled in this embodiment. In the case of the cooling zones 158, 160 utilizing cooling gas, minimal leakage of cooling gas is experienced with this SPF 130 as a result of both sides thereof presenting substantially planar surfaces to the respective cooling zone. To minimize possible damage during pump-down, bleed holes 162 can be provided.

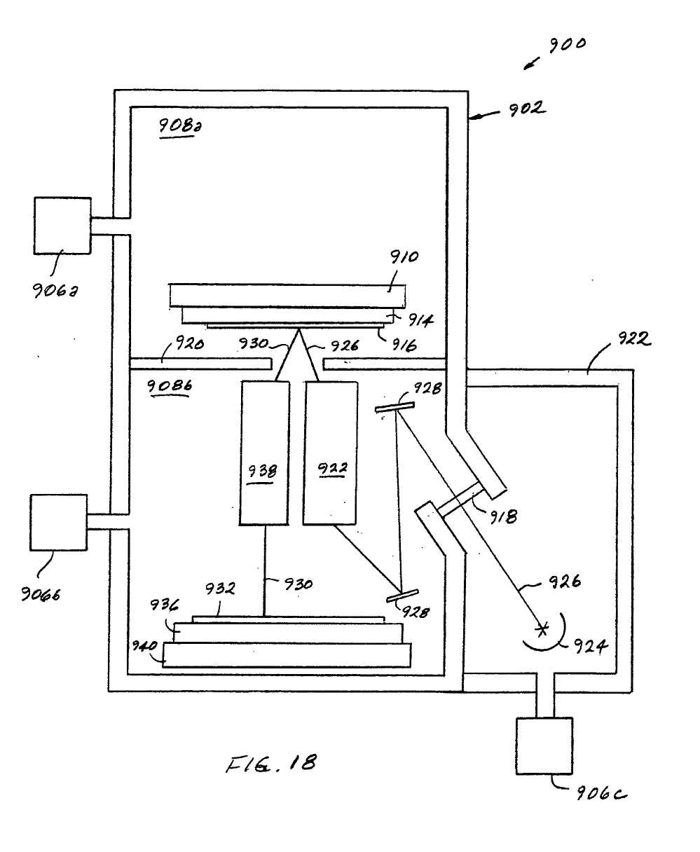

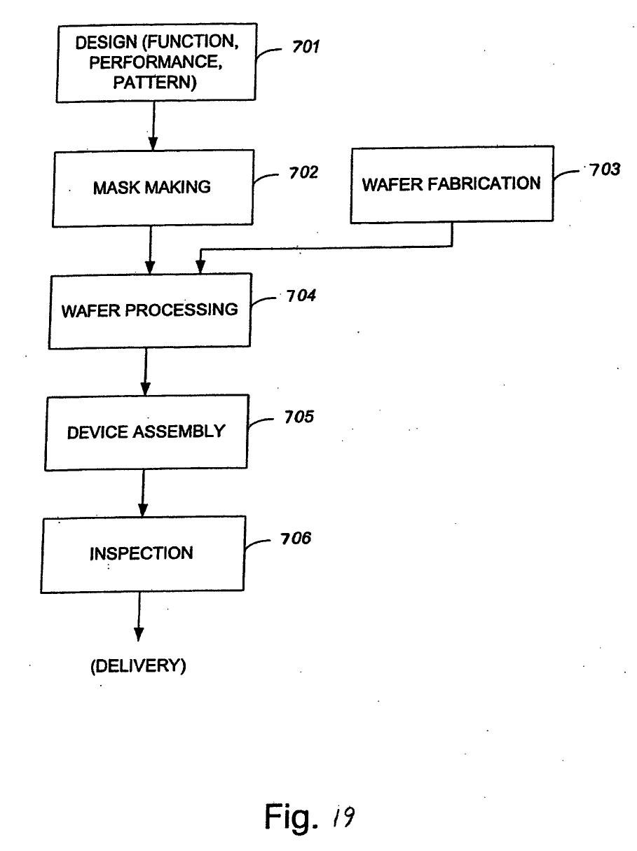

FIG. 17 depicts a manner in which two disk-shaped SPF portions 180, 182 can be joined together (arrows 184), in the manner shown in FIG. 16 and discussed above. The first SPF portion 180 defines linear slotted waveguides 186 that are oriented radially, and the second SPF portion 182 defines slotted waveguides 188 that are oriented circumferentially, at right angles to the waveguides 186. After being joined together, the resulting SPF assembly is rotatable about the axis A in the manner shown, for example, in FIG. 1.

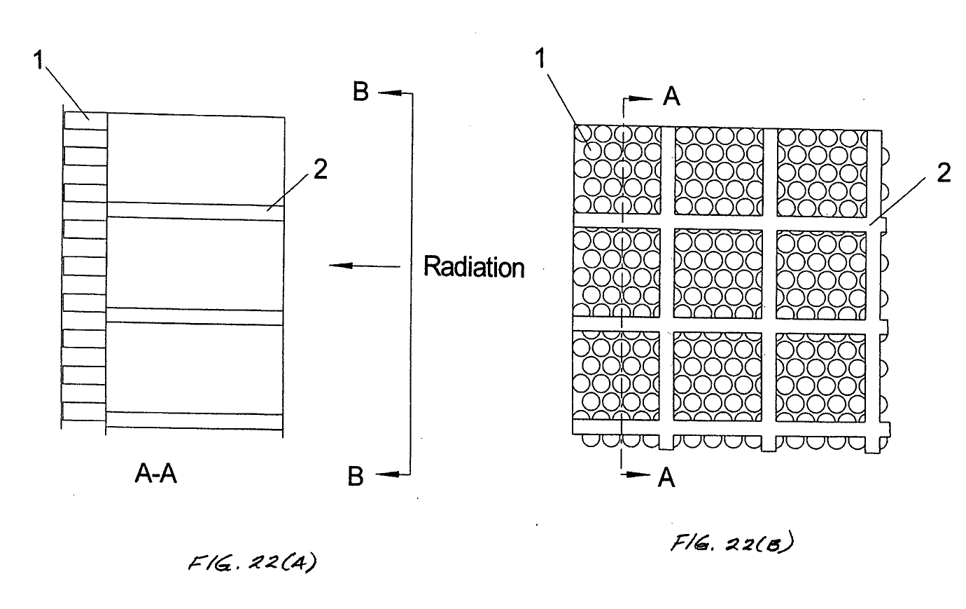

As another example of two SPFs being combined to yield new capabilities, FIGS. 22(A) and 22(B) show orthogonal views of two SPFs with different functions. SPF 1 provides EUV and out-of-band filtering capabilities similar to the embodiment shown in FIG. 8. SPF 2 lies on the radiation side of SPF 1 and reduces the intensity of the longer wavelength components of the EUV source, thereby reducing the heat load on SPF 1. The attenuation is achieved by the waveguide properties of SPF 2. To maximize transmission of in-band EUV radiation, SPF 2 may have no thin membrane covering the ends of the lattice-like frame shown. However, a thin membrane could be added, if gas leakage in the cooling zone were a problem.

EUVL Systems

Referring now to FIG. 18, an embodiment of an EUVL system 900 is shown. The depicted system 900 comprises a vacuum chamber 902 including vacuum pumps 906a, 906b that are arranged to enable desired vacuum levels to be established and maintained within respective chambers 908a, 908b of the vacuum chamber 902. For example, the vacuum pump 906a maintains a vacuum level of approximately 50 mTorr in the upper chamber (reticle chamber) 908a, and the vacuum pump 906b maintains a vacuum level of less than approximately 1 mTorr in the lower chamber (optical chamber) 908b. The two chambers 908a, 908b are separated from each other by a barrier wall 920. Various components of the EUVL system 900 are not shown, for ease of discussion, although it will be appreciated that the EUVL system 900 can include components such as a reaction frame, a vibration-isolation mechanism, various actuators, and various controllers.

An EUV reticle 916 is held by a reticle chuck 914 coupled to a reticle stage 910. The reticle stage 910 holds the reticle 916 and allows the reticle to be moved laterally in a scanning manner, for example, during use of the reticle for making lithographic exposures. An illumination source 924 is contained in a vacuum chamber 922 evacuated by a vacuum pump 906c. The illumination source 924 produces an EUV illumination beam 926 that is transmitted through an SPF 918 and enters the optical chamber 908b. The illumination beam 926 reflects from one or more mirrors 928 and through an illumination-optical system 922 to illuminate a desired location on the reticle 916. As the illumination beam 926 reflects from the reticle 916, the beam is “patterned” by the pattern portion actually being illuminated on the reticle. The barrier wall 920 defines an aperture 934 through which the illumination beam 926 illuminates the desired region of the reticle 916. The incident illumination beam 926 on the reticle 916 becomes patterned by interaction with pattern-defining elements on the reticle. The resulting patterned beam 930 propagates generally downward through a projection-optical system 938 onto the surface of a wafer 932 held by a wafer chuck 936 on a wafer stage 940 that performs scanning motions of the wafer during exposure. Hence, images of the reticle pattern are projected onto the wafer 932.

The wafer stage 940 can include (not detailed) a positioning stage that may be driven by a planar motor or one or more linear motors, for example, and a wafer table that is magnetically coupled to the positioning stage using an EI-core actuator, for example. The wafer chuck 936 is coupled to the wafer table, and may be levitated relative to the wafer table by one or more voice-coil motors, for example. If the positioning stage is driven by a planar motor, the planar motor typically utilizes respective electromagnetic forces generated by magnets and corresponding armature coils arranged in two dimensions. The positioning stage is configured to move in multiple degrees of freedom of motion, e.g., three to six degrees of freedom, to allow the wafer 932 to be positioned at a desired position and orientation relative to the projection-optical system 938 and the reticle 916.

Movements of the wafer stage 940 and the reticle stage 910 generate reaction forces that may adversely affect performance of the EUVL system 900. Reaction forces generated by motion of the wafer stage 940 may be released mechanically to the floor or ground via a frame member, as discussed in U.S. Pat. No. 5,528,118 and in Japan Kôkai Patent Document No. 8-166475. Reaction forces generated by motions of the reticle stage 910 may be mechanically released to the floor or ground by use of a frame member as described in U.S. Pat. No. 5,874,820 and Japan Kôkai Patent Document No. 8-330224, all of which being incorporated herein by reference in their respective entireties.

An EUVL system including the above-described EUV-source and illumination-optical system can be constructed by assembling various assemblies and subsystems in a manner ensuring that prescribed standards of mechanical accuracy, electrical accuracy, and optical accuracy are met and maintained. To establish these standards before, during, and after assembly, various subsystems (especially the illumination-optical system and projection-optical system) are assessed and adjusted as required to achieve the specified accuracy standards. Similar assessments and adjustments are performed as required of the mechanical and electrical subsystems and assemblies. Assembly of the various subsystems and assemblies includes the creation of optical and mechanical interfaces, electrical interconnections, and plumbing interconnections as required between assemblies and subsystems. After assembling the EUVL system, further assessments, calibrations, and adjustments are made as required to ensure attainment of specified system accuracy and precision of operation. To maintain certain standards of cleanliness and avoidance of contamination, the EUVL system (as well as certain subsystems and assemblies of the system) are assembled in a clean room or the like in which particulate contamination, temperature, and humidity are controlled.

Semiconductor devices can be fabricated by processes including microlithography steps performed using a microlithography system as described above. Referring to FIG. 19, in step 701 the function and performance characteristics of the semiconductor device are designed. In step 702 a reticle defining the desired pattern is designed according to the previous design step. Meanwhile, in step 703, a substrate (wafer) is made and coated with a suitable resist. In step 704 the reticle pattern designed in step 702 is exposed onto the surface of the substrate using the microlithography system. In step 705 the semiconductor device is assembled (including “dicing” by which individual devices or “chips” are cut from the wafer, “bonding” by which wires are bonded to the particular locations on the chips, and “packaging” by which the devices are enclosed in appropriate packages for use). In step 706 the assembled devices are tested and inspected.

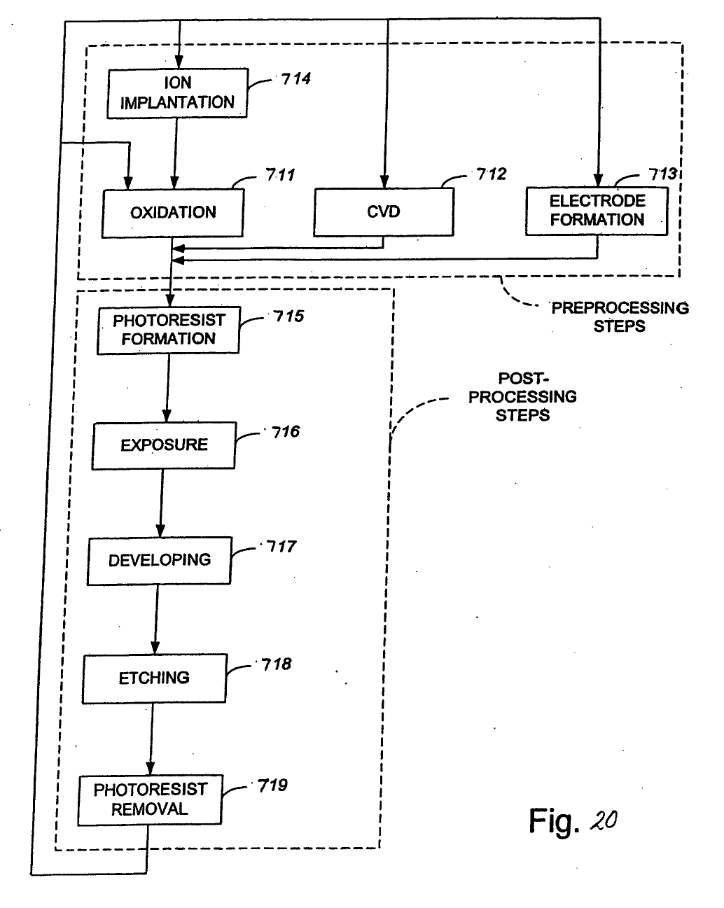

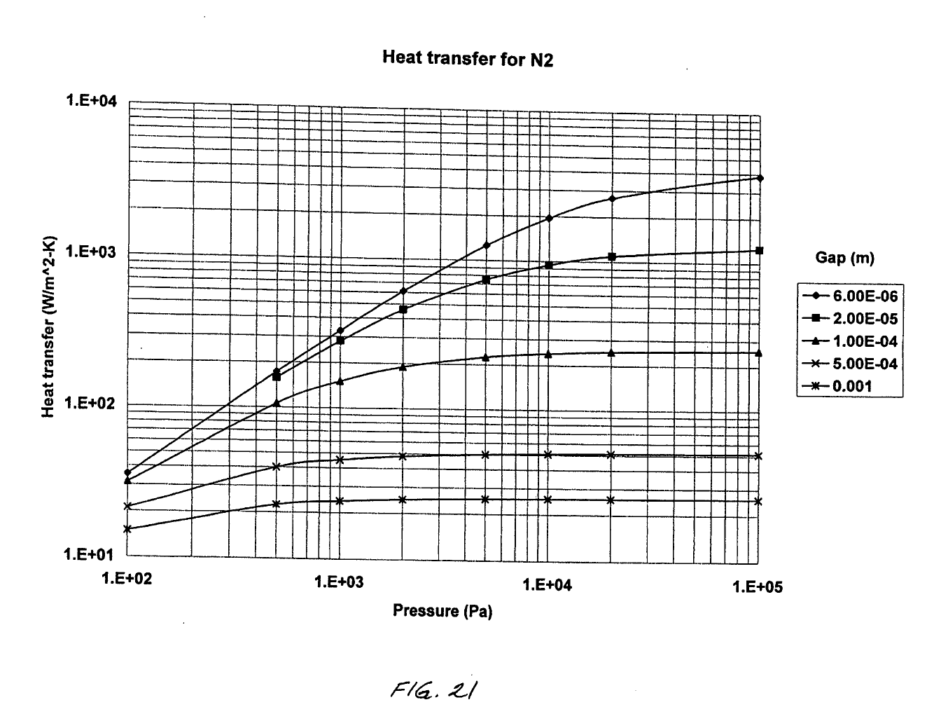

Representative details of a wafer-processing process including a microlithography step are shown in FIG. 20. In step 711 (oxidation) the wafer surface is oxidized. In step 712 (CVD) an insulative layer is formed on the wafer surface. In step 713 (electrode formation) electrodes are formed on the wafer surface by vapor deposition for example. In step 714 (ion implantation) ions are implanted in the wafer surface. These steps 711-714 constitute representative “pre-processing” steps for wafers, and selections are made at each step according to processing requirements.

At each stage of wafer processing, when the pre-processing steps have been completed, the following “post-processing” steps are implemented. A first post-process step is step 715 (photoresist formation) in which a suitable resist is applied to the surface of the wafer. Next, in step 716 (exposure), the microlithography system described above is used for lithographically transferring a pattern from the reticle to the resist layer on the wafer. In step 717 (development) the exposed resist on the wafer is developed to form a usable mask pattern, corresponding to the resist pattern, in the resist on the wafer. In step 718 (etching), regions not covered by developed resist (i.e., exposed material surfaces) are etched away to a controlled depth. In step 719 (photoresist removal), residual developed resist is removed (“stripped”) from the wafer.

Formation of multiple interconnected layers of circuit patterns on the wafer is achieved by repeating the pre-processing and post-processing steps as required. Generally, a set of pre-processing and post-processing steps are conducted to form each layer.

It will be apparent to persons of ordinary skill in the relevant art that various modifications and variations can be made in the system configurations described above, in materials, and in construction without departing from the spirit and scope of this disclosure.

What is claimed is:

1. An apparatus for filtering electromagnetic radiation, comprising:
a filter element, comprising multiple selectable filter regions, situated relative to the electromagnetic radiation such that the electromagnetic radiation can impinge on a selected filter region of the filter element to transmit a first wavelength through the selected filter region while limiting transmission of a second wavelength through the selected filter region;
an actuator coupled to the filter element and configured to move the filter element to select a particular filter region for impingement by the electromagnetic radiation while moving another filter region of the filter element away from impingement by the electromagnetic radiation; and
a filter-cooling device situated and configured to direct a heat-conduction medium at, and thus cool, at least a portion of the filter element.

2. The apparatus of claim 1, wherein the filter-cooling device directs the heat-conduction medium at a filter region not being impinged by the electromagnetic radiation.

3. The apparatus of claim 1, wherein:
the electromagnetic radiation is produced in a first chamber including a dividing wall that defines a window; and
to exit the first chamber the first wavelength propagates through the selected filter region and through the window.

4. The apparatus of claim 3, wherein:
the electromagnetic radiation is generated in the first chamber;
the dividing wall separates the first chamber from a downstream second chamber; and
the first wavelength passes through the selected filter region and the window to the second chamber.

5. The apparatus of claim 4, wherein the first and second chambers are evacuated to respective vacuum levels.

6. The apparatus of claim 1, wherein:
the filter element has a rotational axis; and
the actuator comprises a motor coupled to the filter element so as to rotate the filter element to place the selected filter region for impingement by the electromagnetic radiation.

7. The apparatus of claim 1, wherein the actuator moves the filter element continuously during use of the filter element.

8. The apparatus of claim 1, wherein the actuator moves the filter element intermittently during use of the filter element.

9. The apparatus of claim 1, wherein the actuator moves the filter element periodically during use of the filter element.

10. The apparatus of claim 1, wherein:
the filter element is configured for reciprocating motion; and
the actuator is configured to cause reciprocating motion of the filter element.

11. The apparatus of claim 1, wherein:
the filter-cooling device comprises a cooling zone; and
the actuator is configured to move filter regions of the filter element into and out of the cooling zone.

12. The apparatus of claim 11, wherein the actuator is coupled to the filter element to rotate the filter element to move filter regions of the filter element into and out of the cooling zone.

13. The apparatus of claim 11, wherein:
the heat-conduction medium is a gas; and
the cooling zone is configured to direct flow of the gas to a filter region in the cooling zone.

14. The apparatus of claim 13, wherein the cooling zone further comprises a heat sink configured to remove heat from the gas that has contacted the filter region in the cooling zone.

15. The apparatus of claim 14, wherein the heat sink is actively cooled.

16. The apparatus of claim 13, wherein the cooling zone further comprises a gas-recovery device configured to recover gas that has contacted the filter region in the cooling zone.

17. The apparatus of claim 16, wherein the gas-recovery device is situated so as to flank the gas-film-producing device.

18. The apparatus of claim 1, wherein:
the filter-cooling device comprises multiple cooling zones; and
the actuator is configured to move filter regions of the filter element into and out of the cooling zones.

19. The apparatus of claim 1, wherein:
the filter element is configured as an EUV spectral purity filter element;
the first wavelength of the electromagnetic radiation is a desired wavelength of EUV radiation; and
the second wavelength of electromagnetic radiation is of a group of out-of-band wavelengths.

20. The apparatus of claim 19, wherein the filter element comprises:
a substrate having a first major surface configured to face upstream to receive the beam of electromagnetic radiation, a second major surface configured to face downstream, and a thickness between the major surfaces, the substrate defining multiple waveguides that extend through the thickness dimension and have respective openings on the first and second major surfaces, the waveguides being at least partially transmissive to the desired wavelength of EUV radiation;
an EUV-transmissive layer on the second major surface, the EUV-transmissive layer being at least partially transmissive to the desired wavelength and covering the waveguide openings on the second major surface; and
a reflective layer on the first major surface, the reflective layer being reflective to at least a first portion of the out-of-band radiation so as to prevent the first portion from entering the substrate;
wherein the waveguides attenuate at least a second portion of the out-of-band radiation entering the waveguides from the first major surface, so as to reduce the second portion passing through the waveguides to the EUV-transmissive layer.

21. A spectral purity filter, comprising:
a filter element, comprising multiple selectable filter regions, situated relative to a beam of electromagnetic radiation such that the beam can impinge on a selected filter region to transmit a first wavelength of the electromagnetic radiation through the filter element and to limit transmission of a second wavelength of the electromagnetic radiation through the filter element, wherein impingement by the beam on a selected filter region causes heating of the filter region;
an actuator coupled to the filter element and configured to move the filter element to select a first filter region for impingement by the beam while moving a second filter region of the filter element away from impingement by the beam; and
a cooling device situated and configured to direct a heat-conduction medium at, and thus remove heat from, at least the second filter region.

22. The filter of claim 21, wherein the cooling device removes heat from at least the second filter region while the beam is impinging on the first filter region.

23. The filter of claim 21, wherein the actuator is coupled to the filter element in a manner by which the actuator device rotates the filter element.

24. The filter of claim 21, wherein the actuator is coupled to the filter element in a manner by which the actuator moves the filter element in a reciprocating manner.

25. The filter of claim 21, wherein the cooling device comprises a gas-flow device that directs a flow of a gas to at least the second filter region.

26. The filter of claim 25, wherein the cooling device further comprises a gas-recovery device situated and configured to recover gas of the gas flow that has contacted at least the second filter region.

27. The filter of claim 21, wherein:
the filter element is configured as an EUV spectral purity filter element;
the first wavelength of the electromagnetic radiation is a desired wavelength of EUV radiation; and
the second wavelength of electromagnetic radiation is of a group of out-of-band wavelengths.

28. The filter of claim 27, wherein the filter element comprises:
a substrate having a first major surface facing upstream to receive the beam of electromagnetic radiation, a second major surface facing downstream, and a thickness dimension between the major surfaces, the substrate defining multiple waveguides that extend through the thickness dimension and have respective ends at the first and second major surfaces, at least some of the waveguides being at least partially transmissive to the desired wavelength of EUV radiation;
an EUV-transmissive layer on the second major surface, the EUV-transmissive layer being at least partially transmissive to the desired wavelength and covering at least some of the ends of the waveguides on the second major surface; and
a reflective layer on the first major surface, the reflective layer being reflective to at least a first portion of the out-of-band radiation;
wherein the waveguides attenuate at least a second portion of the out-of-band radiation entering the waveguides from the first major surface.

29. The filter of claim 28, wherein:
the first major surface is substantially planar; and
the cooling device is configured to direct a heat-conduction medium to at least the first major surface in the second filter region.

30. The filter of claim 29, wherein:
the second major surface is substantially planar;
the cooling device is further configured to direct a heat-conduction medium to at least the second major surface in the second filter region.

31. An EUV spectral purity filter for placement downstream of an EUV source that produces a desired wavelength of EUV radiation as well as out-of-band radiation, the filter comprising:
a substrate having a first major surface facing upstream generally toward the EUV source, a second major surface facing generally downstream, and a thickness between the major surfaces, the substrate defining multiple waveguides that extend through the thickness and have respective ends at the first and second major surfaces, the waveguides being at least partially transmissive to the desired wavelength of EUV radiation;
an EUV-transmissive layer on the second major surface, the EUV-transmissive layer being at least partially transmissive to the desired wavelength and covering at least some of the waveguide openings at the second major surface; and
a reflective layer on the first major surface, the reflective layer exhibiting reflectivity to at least a first portion of the out-of-band radiation so as to prevent the first portion from entering the substrate;
wherein the waveguides attenuate at least a second portion of the out-of-band radiation entering the waveguides from the first major surface, so as to reduce the second portion passing through the waveguides to the EUV-transmissive layer.

32. The filter of claim 31, wherein:
the substrate is silicon;
the EUV-transmissive layer comprises SiO₂; and
the reflective layer comprises a metal.

33. The filter of claim 32, wherein the metal is Zr or Nb.

34. The filter of claim 31, wherein the EUV-transmissive layer extends planarly over the openings of the waveguides on the second major surface.

35. The filter of claim 31, wherein the EUV-transmissive layer comprises respective non-planar shells covering the openings of the waveguides on the second major surface.

36. The filter of claim 31, wherein the waveguides are in a regular array.

37. The filter of claim 31, wherein the waveguides have round transverse profiles.

38. The filter of claim 31, wherein the waveguides have rectilinear transverse profiles.

39. The filter of claim 31, wherein the waveguides have slot-shaped transverse profiles.

40. The filter of claim 39, wherein the waveguides include a first group of which the respective slot-shaped transverse profiles extend in a first direction and a second group of which the respective slot-shaped profiles extend in a second direction that is substantially orthogonal to the first direction.

41. The filter of claim 40, wherein:
the substrate comprises a downstream portion and an upstream portion substantially parallel to each other:
the waveguides of the first group are defined in and extend through a thickness dimension of the upstream portion of the substrate; and
the waveguides of the second group are defined in and extend through a thickness dimension of the downstream portion of the substrate.

42. The filter of claim 41, wherein the upstream and downstream portions of the substrate are bonded to each other.

43. The filter of claim 42, wherein:
the upstream portion of the substrate includes the first major surface and defines respective struts;
the downstream portion of the substrate includes the second major surface and defines respective struts; and
the upstream and downstream portions are bonded to each other strut-to-strut.

44. The filter of claim 31, wherein respective portions of the reflective layer extend into the waveguides from the first major surface.

45. An optical system, comprising:
a first chamber containing a radiation source that produces a beam of electromagnetic radiation;
a second chamber situated relative to the source chamber;
a propagation pathway for the beam from the first chamber to the second chamber;
a filter element, comprising multiple selectable filter regions, situated relative to the propagation pathway such that the beam can impinge on a selected filter region to transmit a first wavelength of the electromagnetic radiation through the filter element while limiting transmission of a second wavelength of the electromagnetic radiation;
an actuator coupled to the filter element and configured to move the filter element to place a first filter region relative to the propagation pathway for impingement by the beam while moving a second filter region of the filter element away from the propagation pathway; and
a cooling device situated and configured to direct contact of a heat-conduction medium with at least the second filter region.

46. The system of claim 45, further comprising a wall at least partially separating the second chamber from the first chamber, the wall defining the propagation pathway and an inner chamber containing the filter element and in which the filter element moves by the actuator, relative to the propagation pathway.

47. The system of claim 46, wherein:
the heat-conduction medium is a gas; and
the cooling device comprises a gas-film-producing device that directs, in the inner chamber, a flow of a film of the gas to at least the second filter region.

48. The system of claim 47, wherein the cooling device further comprises a gas-recovery device situated and configured to recover, in the inner chamber, at least some of the gas that has been directed to at least the second filter region.

49. The system of claim 48, wherein the gas-recovery device surrounds the gas-film-producing device.

50. The system of claim 45, wherein:
the filter element is configured as an EUV spectral purity filter element;
the first wavelength of the electromagnetic radiation is a desired wavelength of EUV radiation; and
the second wavelength of electromagnetic radiation is of a group of out-of-band wavelengths.

51. The system of claim 50, wherein the filter element comprises:
a substrate having a first major surface facing upstream to receive the beam of electromagnetic radiation, a second major surface facing downstream, and a thickness between the major surfaces, the substrate defining multiple waveguides that extend through the thickness and have respective ends at the first and second major surfaces, the waveguides being at least partially transmissive to the desired wavelength of EUV radiation;
an EUV-transmissive layer on the second major surface, the EUV-transmissive layer being at least partially transmissive to the desired wavelength and covering the waveguide ends on the second major surface; and
a reflective layer on the first major surface, the reflective layer being reflective to at least a first portion of the out-of-band radiation so as to prevent the first portion from entering the substrate;
wherein the waveguides attenuate at least a second portion of the out-of-band radiation entering the waveguides from the first major surface, so as to reduce the second portion passing through the waveguides to the EUV-transmissive layer.

52. An apparatus for filtering electromagnetic radiation, the apparatus comprising:
filter-element means for providing multiple selectable filter regions that transmit a first wavelength of the electromagnetic radiation and limit transmission of a second wavelength of the electromagnetic radiation;
actuator means for moving the filter-element means relative to a propagation pathway for selecting a particular filter region for alignment with the propagation pathway while moving another filter region of the filter element out of alignment with the propagation pathway; and
filter-cooling means for directing a heat-conductive medium at the filter-element means so as to cool the filter-element means.

53. The apparatus of claim 52, wherein the filter-cooling means directs the heat-conductive medium at a filter region not aligned with the propagation pathway.

54. The apparatus of claim 53, wherein the filter-cooling means comprises gas-film-discharge means for directing a film of a gas at the filter region not aligned with the propagation pathway.

55. The apparatus of claim 54, wherein the filter-cooling means further comprises gas-recovery means for recovering gas directed by the gas-film-discharge means.

56. The apparatus of claim 53, wherein:
said filter-element means comprises EUV SPF means;
the first wavelength of the electromagnetic radiation is a desired wavelength of EUV radiation; and
the second wavelength of electromagnetic radiation is of a group of out-of-band wavelengths.

57. The apparatus of claim 56, wherein said EUV SPF means comprises:
substrate means for providing a first major surface configured to face upstream to receive the beam of electromagnetic radiation, for providing a second major surface configured to face downstream, and for providing a thickness dimension between the major surfaces, said substrate means defining waveguide means, extending through the thickness dimension, for transmitting at least a portion of the desired wavelength of EUV radiation;
EUV-transmissive means, on the second major surface, for at least partially transmitting the desired wavelength and for covering ends of said waveguide means on the second major surface; and
reflection means, on the first major surface, for reflecting at least a first portion of the out-of-band radiation so as to prevent the first portion from entering said substrate means;
said waveguide means being further for attenuating at least a second portion of the out-of-band radiation entering said waveguide means from the first major surface, so as to reduce the second portion passing through said waveguide means to said EUV-transmissive means.

58. A spectral purity filter, comprising:
filter-element means for placing a selected one of multiple selectable filter regions relative to a beam of electromagnetic radiation such that the beam can impinge on a selected filter region to transmit a first wavelength of the electromagnetic radiation through the filter element and to attenuate transmission of a second wavelength of the electromagnetic radiation, wherein impingement by the beam on a filter region causes heating of the filter region;
actuator means for moving the filter element to select a first filter region for impingement by the beam while moving a second filter region of the filter element away from impingement by the beam; and
cooling means for directing a heat-conductive medium at, and thus removing heat from, at least the second filter region.

59. The filter of claim 58, wherein the cooling means comprises gas-film-discharge means for directing a film of a heat-conductive gas at the second filter region to remove heat from the second filter region.

60. The filter of claim 59, wherein the cooling means further comprises gas-recovery means for recovering gas discharged at the second filter region by the gas-film-discharge means.

61. An optical system, comprising:
radiation-source means for producing a beam of electromagnetic radiation;
first chamber means for containing the radiation-source means;
second chamber means, located downstream of the first chamber means;
propagation-pathway means for passing the beam from the first chamber to the second chamber;
filter-element means for providing multiple selectable filter regions relative to the propagation-pathway means such that the beam can impinge on a selected filter region to transmit a first wavelength of the electromagnetic radiation through the filter element and propagation-pathway means to attenuate transmission of a second wavelength of the electromagnetic radiation;
actuator means for moving the filter element and placing a first filter region relative to the propagation-path means for impingement by the beam while moving a second filter region of the filter element away from the propagation-path means; and
cooling means for directing a heat-conductive medium at the second filter region for removing heat from at least the second filter region.

62. The optical system of claim 61, wherein the cooling means comprises gas-film-discharge means for directing a film of a heat-conductive gas at the second filter region to remove heat from at least the second filter region.

63. The optical system of claim 62, wherein the cooling means further comprises gas-recovery means for recovering gas discharged by the gas-film-discharge means.

64. The optical system of claim 61, wherein:
said filter-element means comprises EUV SPF means;
the first wavelength of the electromagnetic radiation is a desired wavelength of EUV radiation; and
the second wavelength of electromagnetic radiation is of a group of out-of-band wavelengths.

65. The optical system of claim 64, wherein said EUV SPF means comprises:
substrate means for providing a first major surface configured to face upstream to receive the beam of electromagnetic radiation, for providing a second major surface configured to face downstream, and for providing a thickness dimension between the major surfaces, said substrate means defining waveguide means, extending through the thickness dimension, for transmitting at least a portion of the desired wavelength of EUV radiation;
EUV-transmissive means, on the second major surface, for at least partially transmitting the desired wavelength and for covering openings of said waveguide means on the second major surface; and
reflection means, on the first major surface, for reflecting at least a first portion of the out-of-band radiation so as to prevent the first portion from entering said substrate means;
said waveguide means being further for attenuating at least a second portion of the out-of-band radiation entering said waveguide means from the first major surface, so as to reduce the second portion passing through said waveguide means to said EUV-transmissive means.

66. A method for removing heat from a filter element that receives a beam electromagnetic radiation and transmits a first wavelength of the electromagnetic radiation while limiting transmission of a second wavelength of the electromagnetic radiation, the method comprising:
configuring the filter element with multiple filter regions that are selectable, by moving the filter element, for receiving the beam of electromagnetic radiation;
after irradiating a selected filter region with the beam of electromagnetic radiation, moving the filter element so as to move the filter region away from being irradiated by the beam; and
directing a heat-conductive medium at the moved filter region so as to cool the moved filter region.

67. The method of claim 66, wherein the step of directing the heat-conductive medium comprises directing flow of a film of gas to the filter region that has been moved away from the beam.

68. The method of claim 67, further comprising recovering the gas directed at the filter region.

69. An optical system, comprising an apparatus as recited in claim 1.

70. An optical system, comprising an apparatus as recited in claim 20.

71. An optical system, comprising a spectral purity filter as recited in claim 21.

72. An optical system, comprising a spectral purity filter as recited in claim 28.

73. An EUV optical system, comprising an EUV spectral purity filter as recited in claim 31.

74. A lithography system, comprising an optical system as recited in claim 45.

75. An optical system, comprising an apparatus as recited in claim 52.

76. An optical system, comprising an apparatus as recited in claim 57.

77. An optical system, comprising a spectral purity filter as recited in claim 58.

78. A lithography system, comprising an optical system as recited in claim 61.

79. An EUV lithography system, comprising an optical system as recited in claim 65.
